(19) United States
(12) Patent Application Publication
(10) Pub. No.: US 2026/0360754 A1
(43) Pub. Date: Nov. 12, 2026

(54) COMPOSITE CURRENT COLLECTOR, AND MANUFACTURING METHOD THEREFOR AND APPLICATION THEREOF

(71) Applicant: JIANGYIN NANOPORE INNOVATIVE MATERIALS TECHNOLOGY LTD, Jiangyin City Wuxi, Jiangsu (CN)

(72) Inventors: Zhongya ZHU, Jiangyin City Wuxi, Jiangsu (CN); Jianzhong XIA, Jiangyin City Wuxi, Jiangsu (CN); Laiyuan ZENG, Jiangyin City Wuxi, Jiangsu (CN); Mengjie HAN, Jiangyin City Wuxi, Jiangsu (CN); Shuai WANG, Jiangyin City Wuxi, Jiangsu (CN); Xiaonan CHI, Jiangyin City Wuxi, Jiangsu (CN); Xuefa LI, Jiangyin City Wuxi, Jiangsu (CN); Guoping ZHANG, Jiangyin City Wuxi, Jiangsu (CN)

(21) Appl. No.: 19/488,554

(22) PCT Filed: May 27, 2024
(86) PCT No.: PCT/CN2024/095406

§ 371 Date: Nov. 26, 2025

(30) Foreign Application Priority Data
May 31, 2023 (CN) 202310646150.9
May 31, 2023 (WO) PCT/CN2023/097489
Nov. 14, 2023 (CN) 202311513637.6
Dec. 27, 2023 (CN) 202311838629.9
Jan. 18, 2024 (WO) PCT/CN2024/073039
May 17, 2024 (CN) 202410622655.6

(51) Int. Cl. H01M 4/66; H01M 4/02; H01M 4/04

(52) U.S. Cl. CPC H01M 4/667; H01M 4/0426; H01M 4/0428; H01M 4/0452; H01M 4/662; H01M 4/668; H01M 2004/021

(57) ABSTRACT

A composite current collector, and manufacturing method therefor and an application thereof. The composite current collector comprises a conductive layer; and the conductive layer comprises a metal layer and an intermediate layer which are alternately stacked. On the one hand, the conductive layer generates micro-cracks in the nail penetration process, and the micro-cracks propagate to cause large-area breakage, such that the conductive layer is separated from a nail, positive and negative electrode current collectors are prevented from being conducted to form a closed loop, and thermal runaway of a battery caused by the closed loop is avoided, thereby greatly improving the safety performance of the battery. On the other hand, the intermediate layer can effectively inhibit the corrosion of the metal layer by fluorine ions in an electrolyte, such that the stability of the performance of the composite current collector in the charging and discharging cycle process can be improved.

### TECHNICAL FIELD

The present disclosure relates to the technical field of new energy batteries, for example, a composite current collector, a preparation method therefor, and a use thereof.

### BACKGROUND

At present, composite current collectors based on polymer films have attracted widespread attention and have been widely applied in the new energy industry. To prepare such composite current collectors, a layer of metal is generally deposited on a polymer film (such as polyester or polyolefin) by a physical vapor deposition (PVD) method, so as to prepare a composite current collector with good conductivity. Compared with traditional current collectors, composite current collectors based on polymer films have the characteristics of low cost, light weight, good internal insulation, etc. Due to these characteristics, the composite current collectors can reduce the cost of batteries and improve the energy density and safety of the batteries when applied to the batteries.

The present composite current collector mainly improves the safety of a battery by means of the insulation and flame retardant properties of an intermediate layer, that is, the polymer film. However, the safety of the battery is improved to a limited extent.

Therefore, providing a current collector structure that achieves high safety without affecting battery performance is a technical problem to be solved urgently.

### SUMMARY

The following is a summary of the subject matter described in detail herein. This summary is not intended to limit the scope of the claims.

The present disclosure provides a composite current collector, a preparation method therefor, and a use thereof. According to the composite current collector structure of the present disclosure, during a needle puncture process, a conductive layer generates microcracks and the microcracks propagate rapidly to cause large-area fractures so that the conductive layer is separated from a steel needle, thereby avoiding a closed loop due to the conduction between positive and negative current collectors and the resulting thermal runaway of a battery and greatly improving the safety of the battery.

In a first aspect, the present disclosure provides a composite current collector. The composite current collector includes a conductive layer, wherein the conductive layer includes a metal layer and an intermediate layer stacked alternately.

In some embodiments, during a needle puncture process, the conductive layer generates microcracks and the microcracks propagate to cause large-area fractures so that the conductive layer is separated from a steel needle.

The conductive layer of the present disclosure may include the metal layer(s) and the intermediate layer(s) stacked alternately, During a needle puncture experiment of a battery, the intermediate layer(s) are easy to generate cracks, and the cracks propagate rapidly to the surroundings to drive large-area fractures and fragmentation of adjacent metal layers so that the conductive layer is separated from the steel needle, thereby avoiding a closed loop due to the conduction between positive and negative current collectors and the resulting thermal runaway of the battery and improving the safety of the battery.

Specifically, the intermediate layer(s) of the present disclosure have the following functions: (1) the intermediate layer(s) can block the penetration of grains in adjacent metal layers and promote the re-nucleation and growth of grains, thereby generating non-penetrating and small-sized grains, and the metal layer composed of the generated non-penetrating and small-sized grains produces microcracks after certain deformation during the needle puncture process of the battery and the microcracks propagate rapidly to the surroundings to cause the large-area fractures and fragmentation of the metal layer, so that the metal layer is separated from the steel needle, thereby avoiding the closed loop due to the conduction between the positive and negative current collectors and the resulting thermal runaway of the battery and improving the safety of the battery; (2) the intermediate layer(s) can reinforce the strain hardening of the composite current collector and reduce local stress concentration to promote the propagation of cracks due to the deformation of the metal layer of the composite current collector during the needle puncture process of the battery to the surroundings and continuously promote the large-area fractures and fragmentation of the metal layer, thereby avoiding the closed loop due to the conduction between the positive and negative current collectors and the resulting thermal runaway of the battery and improving the safety of the battery.

In some embodiments, during the needle puncture process, the conductive layer generates the microcracks and the microcracks propagate rapidly to cause the large-area fractures so that the conductive layer is separated from the steel needle, thereby avoiding the closed loop due to the conduction between the positive and negative current collectors and the resulting thermal runaway of the battery, improving the safety of the battery, and facilitating the promotion and application of the composite current collector.

In some embodiments, the intermediate layer(s) of the present disclosure are partially crystalline or completely non-crystalline (amorphous), and the metal layer of the present disclosure is crystalline.

Optionally, the composite current collector includes a base film and a functional layer located on at least one side of the base film, where the functional layer includes the conductive layer, and the conductive layer includes the metal layer(s) and the intermediate layer(s) stacked alternately.

According to the composite current collector structure of the present disclosure, through the collaboration of various structural layers in the functional layer, during the needle puncture process, the conductive layer generates the microcracks and the microcracks propagate rapidly to cause the large-area fractures so that the conductive layer is separated from the steel needle, thereby avoiding the closed loop due to the conduction between the positive and negative current collectors and the resulting thermal runaway of the battery, improving the safety of the battery, and facilitating the promotion and application of the composite current collector.

The intermediate layer(s) in the conductive layer inhibit the continuous growth of grains in the metal layer(s), thereby preparing the conductive layer with non-penetrating and small-sized metal grains, ensuring that the cracks generated by the conductive layer during the needle puncture process are easy to propagate over a large area to cause the large-area fractures of the conductive layer, and avoiding the battery safety problem due to the conduction between the positive and negative current collectors. If the conductive layer includes only the metal layer(s), the cracks generated during the needle puncture process cannot propagate over a large area. Moreover, the intermediate layer(s) and the metal layer(s) have non-porous structures. If the intermediate layer(s) and the metal layer(s) are interconnected through pores, the continuous growth of grains in the metal layer cannot be inhibited, which is not conducive to improving the safety of the battery. A protective layer isolates the conductive layer from direct contact with an electrolyte, avoiding the erosion of the electrolyte.

The metal layer in the composite current collector of the present disclosure has conductivity, and the intermediate layer(s) (such as an oxide layer) can effectively inhibit the corrosion of the metal layer(s) by fluoride ions in the electrolyte, thereby improving the stability in the performance of the composite current collector in charge discharge cycles and facilitating the promotion and application of the composite current collector. Moreover, the presence of the intermediate layer(s) can improve the elongation at break of the composite current collector. This is because the amorphous material (such as a metal oxide) of the intermediate layer(s) can promote a slip between metal layers in a stretching process, and the regular structure of alternate intermediate layers and metal layers can regulate the transport of electron flows and promote the rapid conduction of the electron flows along a direction parallel to the metal layer(s). It is to be understood that the composite conductive layer may be located on one side or two sides of a polymer film in a thickness direction of the polymer film. In the composite current collector, an innermost layer in the composite conductive layer may be the intermediate layer(s) or the metal layer(s), and an outermost layer in the composite conductive layer may be the intermediate layer or the metal layer.

In the present application, the outermost layer in the composite conductive layer refers to a surface layer of the composite conductive layer facing away from the polymer film, and the innermost layer in the composite conductive layer refers to a bottom layer of the composite conductive layer facing the polymer film.

In some embodiments, the outermost layer in the composite conductive layer is the intermediate layer (such as a metal oxide layer). In the composite current collector, the intermediate layer (such as the metal oxide layer) as the outermost layer in the composite conductive layer (i.e., a layer farthest from the polymer film) can further inhibit the corrosion of the metal layer by the fluoride ions and prevent the metal layer from chemical corrosion or physical damage.

In some embodiments, the innermost layer in the composite conductive layer is the intermediate layer. In the composite current collector, the intermediate layer as the innermost layer in the composite conductive layer can improve the adhesion strength between the composite conductive layer and the polymer film.

In some embodiments, the base film has a thickness of 1-10 μm. The thickness of the base film is controlled within the above range to help reduce the preparation difficulty and cost of the base film and promote the application of the composite current collector including the base film in the battery. Optionally, the base film may be prepared by a melt-extrusion-biaxial stretching method. It is to be understood that the thickness of the base film includes, but is not limited to, for example, 1 μm, 2 μm, 3 μm, 4 μm, 5 μm, 6 μm, 7 μm, 8 μm, 9 pun, or 10 μm.

In some embodiments, the base film is made of any one or a combination of at least two selected from polyethylene terephthalate (PET), polypropylene (PP), polybutylene terephthalate (PBT), polyethylene naphthalate (PEN), polyethylene (PE), polyphenylene ether, polyvinyl chloride (PVC), polyvinylidene fluoride (PVDF), polytetrafluoroethylene (PTFE), polyphenylene sulfide (PPS), polyphenylene oxide (PPO), polystyrene (PS), and polyimide (PI).

The material of the base film of the present disclosure is not limited to the above types of materials, and base film materials that can be used in current collector structures are all applicable to the present disclosure.

In some embodiments, an adhesive layer is further provided between the base film and the conductive layer.

In the present disclosure, the adhesive layer is further introduced into the functional layer, and the adhesive layer assists in and collaborates with the conductive layer. The adhesive layer provides appropriate adhesion strength between the conductive layer and the polymer film of the composite current collector so that a certain relative motion between the conductive layer and the polymer film occurs during deformation of the composite current collector, thereby promoting the deformation and breakage of the conductive layer and improving the safety of the battery. If the adhesive layer is omitted, the safety of the battery is deteriorated.

Optionally, adhesion strength between the adhesive layer and the conductive layer is 100-900 N/m, for example, 100 N/m, 150 N/m, 200 N/m, 250 N/m, 300 N/m, 350 N/m, 400 N/m, 450 N/m, 500 N/m, 550 N/m, 600 N/m, 650 N/m, 700 N/m, 750 N/m, 800 N/m, 850 N/m, or 900 N/m.

In the present disclosure, the adhesion strength between the adhesive layer and the conductive layer is adjusted, thereby adjusting the mutual movement between the base film and the conductive layer during deformation of the composite current collector and affecting the deformation and breakage of the conductive layer. Too weak adhesion strength easily results in excessive relative motion between the conductive layer and the polymer film during the needle puncture process of the battery, which weakens the force applied to the conductive layer along a surface, inhibits the large-area extension and propagation of the cracks in the conductive layer, and deteriorates the safety of the battery. Excessive adhesion strength prevents local micro-deformation, which hinders the large-area extension and propagation of the cracks in the conductive layer and compromises the safety of the battery.

In some embodiments, the adhesive layer is made of any one or a combination of at least two selected from aluminum oxide, silicon oxide, titanium oxide, nickel, chromium, titanium, a nickel-chromium alloy, a nickel-chromium-copper alloy, a silicon-aluminum alloy, polyacrylic acid, polyacrylate, polyacrylamide, and polyurethane.

In an embodiment, a thickness of the adhesive layer is 1-100 nm and may be, for example, 1 nm, 3 nm, 5 nm, 7 nm, 9 nm, 10 nm, 20 nm, 30 nm, 40 nm, 50 nm, 60 nm, 70 nm, 80 nm, 90 nm, or 100 nm.

As an optional technical solution of the present disclosure, the composite current collector further includes the protective layer; when the composite conductive layer is disposed on one surface of the polymer base film, the protective layer is disposed on a surface of the composite conductive layer facing away from the polymer base film and the other surface of the polymer base film; or when the composite conductive layer is disposed on one surface of the polymer base film, the protective layer is disposed on a surface of the composite conductive layer facing away from the polymer base film; or when the composite conductive layer is disposed on two surfaces of the polymer base film, the protective layer is disposed on a surface of the composite conductive layer facing away from the polymer base film.

In the present disclosure, the protective layer is used to prevent the composite conductive layer from chemical corrosion or physical damage.

In some embodiments, the thickness of a single protective layer is 5-100 nm and may be, for example, 5 nm, 10 nm, 20 nm, 40 nm, 60 nm, 80 nm, or 100 nm. Optionally, the thickness is 10-80 nm.

In some embodiments, the protective layer is made of any one or a combination of at least two selected from nickel, chromium, a nickel-based alloy, a copper-based alloy, copper oxide, aluminum oxide, nickel oxide, chromium oxide, cobalt oxide, graphite, carbon black, copper chromate, copper chromite, nano-quantum dots, carbon nanotubes, carbon nanofibers, and graphene.

The thickness of the conductive layer of the present disclosure is 500-2000 nm, for example, 500 nm, 600 nm, 800 nm, 900 nm, 1000 nm, 1100 nm, 1200 nm, 1300 nm, 1500 nm, 1800 nm, or 2000 nm. Optionally, the thickness of the conductive layer is 800-1200 nm.

In the present disclosure, when the thickness of the conductive layer is within a range of 500-2000 nm, the current collector structure with good conductivity can be obtained without affecting a normal energy density of the battery. A composite conductive layer that is too thin results in relatively poor conductivity, while a composite conductive layer that is too thick makes the composite current collector excessively thick and heavy, thereby hindering improvements in the energy density of the battery. Considering the conductivity and an improvement of the energy density, the thickness is further adjusted to be within a range of 800-1200 nm, ensuring that the battery has good conductivity and improving the energy density.

Optionally, the thickness d1 of the metal layer satisfies that 0 nm<d1≤300 nm; optionally, 0 nm<d1≤200 nm; further optionally, 20 nm<d1≤200 nm. For example, d1 is 20 nm, 30 nm, 50 nm, 80 nm, 100 nm, 130 nm, 150 nm, 180 nm, or 200 nm. In the present disclosure, if the metal layer is too thin, to ensure the conductivity, the number of metal layers is increased, affecting the production efficiency of the current collector.

In some embodiments, the thickness d2 of the intermediate layer satisfies that 0 nm<d2≤100 nm; optionally, 1 nm≤d2≤50 nm; more optionally, 2 nm≤d2≤50 nm; further optionally, 5 nm≤d2≤20 nm; most optionally, 5 nm≤d2≤10 nm. For example, d2 is 1 nm, 2 nm, 3 nm, 4 nm, 5 nm, 6 nm, 7 nm, 8 nm, 9 nm, or 10 nm. It is to be noted that the single-layer thickness of each intermediate layer may be the same or different, and the single-layer thickness of each metal layer may be the same or different.

When the intermediate layer is made of a conductive material, the thickness of the metal layer of the present disclosure is 0-300 nm excluding 0 and may be, for example, 50 nm, 100 nm, 150 nm, 200 nm, 250 nm, or 300 nm; further optionally, the thickness of the metal layer is 50-200 nm. When the intermediate layer is made of the conductive material, an increase in the thickness of the intermediate layer does not affect the overall conductivity of the composite current collector. Therefore, the thickness d2 of the intermediate layer may not need to satisfy the following condition: the thickness d2 of the intermediate layer is less than or equal to one tenth of the thickness d1 of the metal layer. Optionally, the thickness of the intermediate layer is 0-100 nm excluding 0 and may be, for example, 10 nm, 30 nm, 50 nm, 70 nm, or 90 nm. Further optionally, the thickness of the intermediate layer is 20-80 nm. Optionally, the intermediate layer is made of carbon or copper; more optionally, the intermediate layer is made of partially crystalline or non-crystalline (amorphous) carbon or copper. In the present disclosure, if the amorphous intermediate layer is too thin, the preparation efficiency is affected, and insignificant effects are achieved; if the amorphous intermediate layer is too thick, the material of the amorphous intermediate layer transforms into a crystalline state in a preparation process, which hinders the improvement of the safety of the battery, and the excessive thickness compromises the mechanical performance of the composite copper current collector, resulting in deteriorated mechanical performance.

In some embodiments, the thickness d2 of the intermediate layer is less than or equal to one tenth of the thickness d1 of the metal layer. In the present disclosure, the thickness d2 of the intermediate layer is less than or equal to one tenth of the thickness d1 of the metal layer, which is more conducive to maintaining good conductivity of the composite current collector.

In some embodiments, the total thickness of the intermediate layers accounts for 10% or less of the thickness of the composite conductive layer. The total thickness of the intermediate layers refers to a sum of the thicknesses of all the intermediate layers in the composite conductive layer. When the total thickness of the intermediate layers accounts for a relatively high percentage of the thickness of the composite conductive layer, the composite current collector has relatively poor conductivity.

In some embodiments, when the intermediate layer is made of a non-conductive material, a thickness relationship between the intermediate layer and the metal layer adjacent to each other is optionally that the thickness d3 of the intermediate layer is less than or equal to one tenth of the thickness d4 of the metal layer. The thickness of the intermediate layer is controlled, which is more conducive to maintaining good conductivity of the composite current collector.

In some embodiments, the conductive layer includes n metal layers and n, n+1, or n−1 intermediate layers, where n satisfies that 2≤n≤50; optionally, 5≤n≤40; more optionally, 2≤n≤10. For example, n is 5, 8, 10, 13, 15, 18, 20, 23, 25, 28, 30, 33, 35, 38, or 40.

In some embodiments, the intermediate layer(s) and the metal layer(s) have non-porous structures.

In the conductive layer of the present disclosure, a layer structure adjacent to the adhesive layer or the protective layer may be the metal layer or the intermediate layer. Optionally, a metal layer is in direct contact with the adhesive layer and the protective layer. The stacked structure can better improve the safety of the battery. Further, too few metal layers reduce the effectiveness of the prepared composite current collector in improving the safety of the battery; while too many metal layers result in not only a failure to further improve the safety of the battery but also relatively low production efficiency and a larger production difficulty.

The metal layer(s) of the present disclosure are optionally crystalline, where the crystalline state refers to a dominant form of existence of a solid object in which atoms are regularly arranged. The intermediate layer(s) of the present disclosure are optionally made of amorphous conductive materials. In the present disclosure, “amorphous” or “non-crystalline” refers to structures of amorphous regions (non-crystalline regions) of some partially crystalline solids or configurations of some amorphous solids (non-crystalline solids). The intermediate layer(s) of the present disclosure are optionally partially crystalline or amorphous and made of any one or a combination of at least two selected from an oxide, an alloy, a nitride, a carbide, a sulfide, a fluoride, a silicide, or a phosphide; optionally, the intermediate layer is made of any one or a combination of at least two of the carbide, the silicide, and the fluoride.

In some embodiments, the metal layer(s) are crystalline, and an average grain size of metal grains is 0-200 nm excluding 0, for example, 10 nm, 20 nm, 30 nm, 40 nm, 50 nm, 60 nm, 70 nm, 80 nm, 90 nm, 100 nm, 130 nm, 150 nm, 180 nm, or 200 nm. Optionally, the average grain size of metal grains is 10-100 nm.

In the present disclosure, the metal grains are columnar crystals, and the average grain size of the grains is the diameter of the columnar crystals rather than the length. The average grain size of the metal grains in the metal layer affects the generation of the microcracks in the conductive layer. If the average grain size is too large, the metal layer exhibits stronger plasticity, which is not conducive to the large-area fractures of the metal layer during the needle puncture process, and thus the prepared composite current collector has a worse effect in improving the safety of the battery. The average grain size further adjusted to 10-100 nm enables the generation of the microcracks in the conductive layer without increasing the preparation difficulty, greatly improving the safety of the composite current collector.

A metal in the metal layer of the present disclosure includes any one or a combination of at least two selected from aluminum, copper, gold, silver, nickel, zine, and an alloy thereof. More optionally, the metal layer is a crystalline copper layer. In some embodiments, the metal layer is an aluminum metal layer and optionally a crystalline aluminum metal layer.

In some embodiments, the intermediate layer(s) are made of any one or a combination of at least two selected from a fluorocarbon material, an oxide, an alloy, a nitride, a carbide, a sulfide, a fluoride, a silicide, and a phosphide. The above materials have good barrier and tolerance to the electrolyte and can implement layer-by-layer protection of the metal layer, thereby promoting an improvement in the charge discharge cycle performance of the battery based on the composite copper current collector. Optionally, the intermediate layer(s) are made of any one or a combination of at least two selected from the carbide, the silicide, and the fluoride.

In some embodiments, the intermediate layer(s) include the fluorocarbon material.

In some embodiments, the fluorocarbon material is a fluorocarbon polymer.

In some embodiments, the fluorocarbon polymer is a polymer material including fluorine and carbon elements.

In some embodiments, the fluorocarbon polymer is a polymer material composed of fluorine and carbon elements.

In some embodiments, the fluorocarbon material is a polymer in which C—H bonds are partially or fully substituted with C—F bonds.

In some embodiments, a chemical composition of the fluorocarbon polymer is CₓF_{y}; where 0.6≤x/y≤10. For example, x/y may be 0.6, 1, 2, 3, 4, 5, 6, 7, 8, 9, or 10.

In the present disclosure, if x/y is too low, that is, the carbon content is too low, the intermediate layer(s) exhibit worse conductivity, and thus the prepared composite current collector has worse conductivity, resulting in worse cycle performance of the battery; if x/y is too high, that is, the carbon content is too high, the intermediate layer(s) exhibit worse flexibility and is prone to defects, resulting in worse cycle performance of the battery.

In some embodiments, the weight average molecular weight of the fluorocarbon polymer is 10-100 kDa and may be, for example, 10 kDa, 30 kDa, 50 kDa, 70 kDa, 90 kDa, or 100 kDa. Optionally, the weight average molecular weight of the fluorocarbon polymer is 10-60 kDa.

In some embodiments, the crystallinity of the fluorocarbon polymer ranges from 20% to 80% and may be, for example, 20%, 30%, 40%, 50%, 60%, 70%, or 80%.

In the present disclosure, an improvement in the crystallinity can improve the tolerance of the fluorocarbon layer to the electrolyte and promote the protective effect of the fluorocarbon layer on the metal layer, thereby promoting an improvement in the cycle performance of the battery. However, the crystallinity should not be too high. Excessively high crystallinity results in increased brittleness of the fluorocarbon layer and proneness to defects in a process of manufacturing an electrode sheet of the battery, deteriorating the cycle performance of the battery. According to the present disclosure, compared with the fluorocarbon material, a carbon material is more brittle, which means that the intermediate layer made of the carbon material is more likely to break when subjected to stress or a force. Therefore, during production, a carbon layer is manufactured under higher requirements, materials and processes required for preparing the carbon layer are more complex and sophisticated, and the production process requires stricter control and monitoring.

In some embodiments, the oxide in the intermediate layer includes one or more of a metal oxide or a non-metal oxide; optionally, the metal oxide in the metal oxide layer includes one or more selected from aluminum oxide (Al₂O₃), titanium oxide (TiO₂), copper oxide (CuO), nickel oxide (NiO), chromium oxide (Cr₂O₃), zinc oxide (ZnO), magnesium oxide (MgO), cobalt oxide (CoO), zirconium oxide (ZrO₂), tin oxide (SnO₂), and indium tin oxide (In₂O₃·SnO₂). The above metal oxides have the advantages of easy availability of raw materials and good stability. In some embodiments, the non-metal oxide is silicon oxide. In some optional embodiments, the oxide in the intermediate layer includes one or more selected from aluminum oxide, silicon oxide, and titanium oxide.

In some embodiments, the alloy in the intermediate layer(s) comprises any one or a combination of at least two selected from a nickel-chromium alloy, a nickel-chromium-copper alloy, a nickel-chromium-silicon alloy, a nickel-chromium-cobalt alloy, a silicon-aluminum alloy, an aluminum-silicon-copper alloy, a copper-nickel alloy, a copper-nickel-titanium alloy, a copper-gallium alloy, a copper-indium alloy, a copper-indium-gallium alloy, an aluminum-tin-copper alloy, an aluminum-chromium alloy, a tungsten-titanium alloy, a molybdenum-copper alloy, a molybdenum-niobium alloy, a molybdenum-tantalum alloy, a molybdenum-zirconium-titanium alloy, and a molybdenum-lanthanum alloy.

In some embodiments, the nitride comprises any one or a combination of at least two selected from aluminum nitride, boron nitride, chromium nitride, titanium nitride, silicon nitride, niobium nitride, zirconium nitride, hafnium nitride, tantalum nitride, vanadium nitride, and aluminum titanium nitride.

In some embodiments, the carbide comprises any one or a combination of at least two selected from aluminum carbide, boron carbide, chromium carbide, nickel carbide, tungsten carbide, titanium carbide, hafnium carbide, zirconium carbide, tantalum carbide, lanthanum carbide, molybdenum carbide, niobium carbide, silicon carbide, titanium carbide, and vanadium carbide.

In some embodiments, the sulfide comprises any one or a combination of at least two selected from copper sulfide, tin sulfide, zine sulfide, tungsten sulfide, molybdenum sulfide, iron sulfide, antimony sulfide, chromium sulfide, nickel sulfide, titanium sulfide, aluminum copper sulfide, and iron copper sulfide.

In some embodiments, the fluoride comprises any one or a combination of at least two selected from iridium fluoride, magnesium fluoride, calcium fluoride, lithium fluoride, aluminum fluoride, barium fluoride, samarium fluoride, cerium fluoride, yttrium fluoride, and scandium fluoride.

In some embodiments, the silicide comprises any one or a combination of at least two selected from cobalt silicide, chromium silicide, nickel silicide, titanium silicide, hafnium silicide, molybdenum silicide, niobium silicide, tantalum silicide, vanadium silicide, tungsten silicide, and zirconium silicide.

In some embodiments, the phosphide comprises any one or a combination of at least two selected from aluminum phosphide, boron phosphide, copper phosphide, nickel phosphide, silicon phosphide, tungsten phosphide, gallium phosphide, germanium phosphide, indium phosphide, molybdenum phosphide, niobium phosphide, and tantalum phosphide.

In some embodiments, the protective layer is further provided on a surface of the conductive layer facing away from the base film. In the present disclosure, the protective layer is disposed to prevent the conductive layer from chemical corrosion or physical damage.

In some embodiments, the thickness of the protective layer is 5-100 nm and optionally 10-100 nm, for example 5 nm, 10 nm, 20 nm, 30 nm, 40 nm, 50 nm, 60 nm, 70 nm, 80 nm, 90 nm, or 100 nm. Optionally, the thickness of the protective layer is 20-80 nm.

In some embodiments, the protective layer is made of any one or a combination of at least two selected from nickel, chromium, a nickel-based alloy, a copper-based alloy, copper oxide, aluminum oxide, nickel oxide, chromium oxide, cobalt oxide, copper chromium oxide, graphite, carbon black, carbon nano-quantum dots, carbon nanotubes, carbon nanofibers, graphene, and graphene oxide.

In some embodiments, a surface density of the intermediate layer on a side adjacent to the electrolyte is greater than a surface density of the intermediate layer on a side adjacent to the polymer base film.

In some embodiments, the crystallinity of the intermediate layer ranges from 20% to 80% and may be, for example, 20%, 30%, 40%, 50%, 60%, 70%, or 80%.

In a second aspect, the present disclosure provides a preparation method for the composite current collector of the first aspect. The preparation method comprises: compositing a conductive layer on at least one surface of a base film, wherein the conductive layer comprises a metal layer and an intermediate layer stacked alternately.

In some embodiments, an adhesive layer is further provided between the base film and the conductive layer. Optionally, the adhesive layer is composited by a method including physical vapor deposition or coating. In some specific embodiments, the physical vapor deposition comprises one or more of evaporation or magnetron sputtering.

In some specific embodiments, when the intermediate layer is directly composited on the base film, the intermediate layer serves as the adhesive layer.

Optionally, the metal layer is composited by a method including electroplating, chemical plating, evaporation, and/or magnetron sputtering.

In an embodiment, in the electroplating method, components of an electroplating solution comprise copper sulfate, sulfuric acid, hydrochloric acid, a brightener, a leveling agent, and a wetting agent.

In an embodiment, the concentration of copper sulfate is 80-130 g/L and may be, for example, 80 g/L, 90 g/L, 100 g/L, 110 g/L, 120 g/L, or 130 g/L, the concentration of sulfuric acid is 80-160 g/L and may be, for example, 80 g/L, 100 g/L, 120 g/L, 140 g/L, or 160 g/L, the concentration of chloride ions is 20-80 mg/L and may be, for example, 20 mg/L, 40 mg/L, 60 mg/L, or 80 mg/L, the concentration of the brightener is 5-20 ppm and may be, for example, 5 ppm, 10 ppm, 15 ppm, or 20 ppm, the concentration of the leveling agent is 1-5 ppm and may be, for example, 1 ppm, 3 ppm, or 5 ppm, and the concentration of the wetting agent is 20-200 ppm and may be, for example, 20 ppm, 50 ppm, 100 ppm, 150 ppm, or 200 ppm.

In an embodiment, the brightener comprises any one or a combination of at least two selected from bis-(sodium sulfopropyl)-disulfide, sodium 3-mercapto-1-propane sulfonate, and sodium N,N-dimethyl dithiocarboxamide propanesulfonate.

In an embodiment, the leveling agent comprises any one or a combination of at least two selected from N,N-diethylthiourea, 2-mercaptopyridine, and Janus Green.

In an embodiment, the wetting agent comprises any one or a combination of at least two selected from polyethylene glycol, polypropylene glycol, and polyoxyethylene ether.

In an embodiment, specific process parameters of the electroplating comprise the following: an average cathode current density is 1-3 A/dm² and may be, for example, 1 A/dm², 2 A/dm², or 3 A/dm², a plating solution temperature is 15-35 °C and may be, for example, 15 °C, 20 °C, 25 °C, 30 °C, or 35 °C, and an electroplating time is 1-90 s and may be, for example, 1 s, 10 s, 30 s, 60 s, or 90 s.

In some embodiments, the intermediate layer is prepared by a method including physical vapor deposition or chemical vapor deposition. In some specific embodiments, the physical vapor deposition comprises one or more selected from evaporation and magnetron sputtering. In some embodiments, the intermediate layer is optionally prepared by a magnetron sputtering method.

In some embodiments, specific process parameters of the evaporation include the following: a heating evaporation temperature is 1400-1600 °C and may be, for example, 1400 °C, 1500 °C, or 1600 °C, a coating vacuum degree is <0.1 Pa and may be, for example, 0.08 Pa, 0.06 Pa, or 0.04 Pa, a main roller cooling temperature during coating is −30 °C to −10 °C and may be, for example, −30 °C, −20 °C, or −10 °C, and a coating time is 0.1-10 s and may be, for example, 0.1 s, 1 s, 5 s, or 10 s.

In some embodiments, specific process parameters of the magnetron sputtering include the following: target power is 1-10 KW, for example, 1 KW, 3 KW, 5 KW, 7 KW, 9 KW, or 10 KW; optionally, the target power is 2-6 KW and may be, for example, 2 KW, 4 KW, or 6 KW; a vacuum degree in a chamber during coating is ≤0.1 Pa and may be, for example, 0.1 Pa, 0.08 Pa, or 0.05 Pa; a flowrate of a gas source is 10-500 mL/min and may be, for example, 10 mL/min, 20 mL/min, 50 mL/min, 100 mL/min, 200 mL/min, 300 mL/min, 400 mL/min, or 500 mL/min; optionally, the flowrate is 20-200 mL/min and may be, for example, 20 mL/min, 50 mL/min, 100 mL/min, 150 mL/min, or 200 mL/min; and a coating time is 0.1-60 s and may be, for example, 1 s, 5 s, 10 s, 30 s, or 60 s.

In some embodiments, a type of gas in the gas source may be argon.

In some embodiments, a target material is selected according to a material of the deposited intermediate layer. For example, when the intermediate layer is made of a fluorocarbon material, the target material is a mixture target of a carbon material and a fluorine-containing material. The carbon material comprises graphite. In some embodiments, the fluorine-containing material comprises polytetrafluoroethylene. For example, when the intermediate layer is made of an alloy, nitride, sulfide, fluoride, silicide, or phosphide, the target material is the alloy, nitride, sulfide, fluoride, silicide, or phosphide.

In some embodiments, after the conductive layer is composited, a protective layer is further provided on a surface of the conductive layer facing away from the base film. Optionally, the protective layer is composited by a method including any one or a combination of at least two of physical vapor deposition, chemical vapor deposition, in-situ forming, or coating.

In some embodiments, the chemical vapor deposition comprises atmospheric pressure chemical vapor deposition or plasma-enhanced chemical vapor deposition.

In some embodiments, a specific step of the in-situ forming comprises forming a metal oxide passivation layer in situ on a surface of the metal layer.

In some embodiments, the coating comprises die coating, blade coating, or extrusion coating.

As an optional technical solution of the present application, the preparation method comprises the following steps: (1) preparing a polymer base film having a thickness of 1-10 μm by a melt-extrusion-biaxial stretching method; (2) depositing one adhesive layer having a thickness of 1-100 nm on each of two surfaces of the polymer through physical vapor deposition or coating, to obtain a composite film with adhesive layers on the surfaces; (3) alternately depositing the intermediate layer(s) (such as an amorphous copper layer, a fluorocarbon material layer, an amorphous carbon layer, an oxide layer, an alloy layer, a nitride layer, a carbide layer, a sulfide layer, a fluoride layer, a silicide layer, or a phosphide layer) and the metal layer(s) (such as aluminum, copper, gold, silver, nickel, or zinc and optionally a crystalline copper layer) on each of two surfaces of the composite film, where the number of intermediate layers and the number of metal layers are each ≥2, to obtain a composite film including conductive layers and the adhesive layers; and (4) depositing one protective layer having a thickness of 5-100 nm on each of two surfaces of the composite film comprising the conductive layers and the adhesive layers through physical vapor deposition, chemical vapor deposition, in-situ forming, or coating.

In some embodiments, the metal layer is prepared through physical vapor deposition, for which the specific process parameters include the following: a target material is any one selected from a copper target, an aluminum target, and a copper-aluminum alloy target, a target power is 10-14 KW (which may be, for example, 10 KW, 11 KW, 12 kW, 13 KW, or 14 kW), a gas flowrate is 20-500 mL/min (which may be, for example, 20 mL/min, 40 mL/min, 45 mL/min, 50 mL/min, 55 mL/min, or 60 mL/min), a vacuum degree is ≤0.1 Pa (which may be, for example, 0.1 Pa, 0.08 Pa, 0.05 Pa, or 0.03 Pa), and a coating time of a single metal layer is 5-20 s (which may be, for example, 5 s, 10 s, 15 s, or 20 s).

In some embodiments, the specific process parameters of the magnetron sputtering are selected according to whether the intermediate layer(s) comprise a non-crystalline material and a mass proportion of the non-crystalline material in the intermediate layer(s). For example, the target power is reduced, the flowrate of the gas source is reduced, and/or the main roller cooling temperature during coating is reduced.

In an embodiment, the intermediate layer(s) are the amorphous copper layer(s) prepared through the magnetron sputtering, where preparation process parameters comprise the following: the copper target serves as the target material, the target power is 2-6 kW, the vacuum degree in the chamber during coating is ≤0.1 Pa, the flowrate of the gas source is 10-200 mL/min, the coating time is 0.1-60 s, and the main roller cooling temperature during coating is −30 °C to 0 °C.

In an embodiment, the metal layer(s) are the crystalline copper layer(s) prepared through the electroplating, where preparation process parameters comprise the following: the average cathode current density is 1-3 A/dm², the plating solution temperature is 15 °C to 35 °C, and the electroplating time is 1-90 s.

In some more specific embodiments, the metal layer(s) are prepared through evaporation. Specifically, process conditions for preparing the metal layer(s) include the following: a raw material is any one of copper, aluminum, or a copper-aluminum alloy and optionally a high-purity aluminum wire (purity ≥99.9%), a heating temperature is higher than a melting point of the aluminum wire, a vacuum degree of a vacuum chamber is ≤0.1 Pa, and a period for each deposition is 0.5-40 s. The process conditions of the metal layer(s) made of aluminum, including the above process parameters, are controlled so that the uniformity, compactness, and integrity of the prepared aluminum metal layer(s) can be improved, thereby improving the conductivity of the aluminum metal layer(s). It is to be understood that the vacuum degree of the vacuum chamber includes, but is not limited to, 0.05 Pa, 0.06 Pa, 0.07 Pa, 0.08 Pa, 0.09 Pa, or 0.1 Pa; and the period for each deposition includes, but is not limited to, 0.5 s, 2 s, 5 s, 8 s, 10 s, 12 s, 15 s, 18 s, 20 s, 22 s, 25 s, 28 s, 30 s, 32 s, 35 s, 38 s, or 40 s.

In some more specific embodiments, the metal layer(s) are prepared through magnetron sputtering. Specifically, process conditions for preparing the metal layer(s) include the following: a target material is any one of a copper target, an aluminum target, or a copper-aluminum alloy target and optionally a high-purity aluminum target (purity ≥99.9%), a power supply for the target material is a direct current power supply, a power density is 10-150 W/cm², a vacuum degree of a vacuum chamber is ≤0.5 Pa, a gas source is argon, a flowrate of argon is 10-500 mL/min, and a period for each deposition is 1-60 s.

It is to be noted that the process conditions of the metal layer(s) made of aluminum, including the above process parameters, are controlled so that the uniformity, compactness, and integrity of the prepared aluminum metal layer(s) can be improved, thereby improving the conductivity of the aluminum metal layer(s). It is to be understood that the power density includes, but is not limited to, 10 W/cm², 30 W/cm², 50 W/cm², 70 W/cm², 90 W/cm², 110 W/cm², 130 W/cm², or 150 W/cm²; the vacuum degree of the vacuum chamber includes, but is not limited to, 0.1 Pa, 0.2 Pa, 0.3 Pa, 0.4 Pa, or 0.5 Pa: the flowrate of argon includes, but is not limited to, 10 mL/min, 50 mL/min, 100 mL/min, 150 mL/min, 200 mL/min, 250 mL/min, 300 mL/min, 350 mL/min, 400 mL/min, 450 mL/min, or 500 mL/min; and the period for each deposition includes, but is not limited to, 1 s, 5 s, 10 s, 15 s, 20 s, 25 s, 30 s, 35 s, 40 s, 45 s, 50 s, 55 s, or 60 s.

In some more specific embodiments, the intermediate layer(s) (such as the oxide layer(s) and, in particular, metal oxide layer(s)) are prepared through evaporation. Specifically, preparation process conditions include the following: a raw material is a high-purity metal wire (purity ≥99.9%), and during evaporation, a heating temperature is higher than a melting point of the metal wire, a gas source is oxygen, a flowrate of oxygen is 10-500 mL/min, a vacuum degree of a vacuum chamber is ≤0.5 Pa, and a period for each deposition is 0.1-10 s. The process conditions of the metal oxide layer(s), including the above process parameters, are controlled so that the uniformity, compactness, and integrity of the prepared metal oxide layer(s) can be improved, thereby improving the corrosion resistance (primarily against fluoride ions) of the composite current collector. It is to be understood that the vacuum degree of the vacuum chamber includes, but is not limited to, 0.1 Pa, 0.2 Pa, 0.3 Pa, 0.4 Pa, or 0.5 Pa; and the period for each deposition includes, but is not limited to, 0.1 s, 1 s, 2 s, 3 s, 4 s, 5 s, 6 s, 7 s, 8 s, 9 s, or 10 s.

In some more specific embodiments, the intermediate layer(s) (such as the oxide layer(s) and, in particular, the metal oxide layer(s)) are prepared through magnetron sputtering.

Specifically, process conditions for preparing the metal oxide layer(s) include the following: a target material is a high-purity metal oxide (purity ≥99.9%), a power supply for the target material is a direct current power supply, a power density is 10-150 W/cm², a vacuum degree of a vacuum chamber is ≤0.5 Pa, a gas source is argon, a flowrate of argon is 10-500 mL/min, and a period for each deposition is 0.5-30 s.

It is to be noted that the process conditions of the intermediate layer(s) (such as the oxide layer(s) and, in particular, the metal oxide layer(s)), including the above process parameters, are controlled so that the uniformity, compactness, and integrity of the prepared intermediate layer(s) can be improved, thereby improving the corrosion resistance (primarily against fluoride ions) of the composite current collector. It is to be understood that the power density comprises, but is not limited to, 10 W/cm², 30 W/cm², 50 W/cm², 70 W/cm², 90 W/cm², 110 W/cm², 130 W/cm², or 150 W/cm²; the vacuum degree of the vacuum chamber comprises, but is not limited to, 0.1 Pa, 0.2 Pa, 0.3 Pa, 0.4 Pa, or 0.5 Pa; the flowrate of argon comprises, but is not limited to, 10 mL/min, 50 mL/min, 100 mL/min, 150 mL/min, 200 mL/min, 250 mL/min, 300 mL/min, 350 mL/min, 400 mL/min, 450 mL/min, or 500 mL/min; and the period for each deposition comprises, but is not limited to, 0.5 s, 5 s, 10 s, 15 s, 20 s, 25 s, or 30 s.

In some more specific embodiments, the metal layer(s) are prepared through evaporation, where conditions for preparing the metal layer(s) include the following: a raw material is a high-purity metal wire (purity ≥99.9%), a heating temperature is higher than a melting point of the metal wire, a vacuum degree of a vacuum chamber less than or equal to 0.05 Pa, a period for each coating is 0.5-100 s, and a main roller cooling temperature is −30 °C to 10 °C.

In some more specific embodiments, the metal layer(s) are prepared through magnetron sputtering, where conditions for preparing the metal layer(s) include the following: a target material is a material of the metal layer(s) (purity ≥99.9%), a power supply for the target material is a direct current power supply, target power is 5-20 kW, a vacuum degree of a vacuum chamber is less than or equal to 0.1 Pa, a gas source is argon, a flowrate of argon is 20-500 mL/min, a period for each coating is 0.1-120 s, and a main roller cooling temperature is −20 °C to 30 °C.

In some more specific embodiments, the intermediate layer(s) (such as the alloy, nitride, sulfide, fluoride, silicide, or the phosphide) are prepared through magnetron sputtering. Specifically, process conditions for preparing the intermediate layer(s) include the following: in the magnetron sputtering, a target material is a high-purity target material (purity ≥99.9%), such as the preceding alloy, nitride, sulfide, fluoride, silicide, or the phosphide; target power of a target power supply is 1-10 kW, a vacuum degree of a vacuum chamber is less than or equal to 0.1 Pa, a gas source is argon, a flowrate of argon is 10-500 mL/min, and a period for each coating is 0.1-10 s.

In the preparation method for the composite current collector of the present disclosure, preparation processes are all conventional technical means, and those skilled in the art can adaptively select a preparation method and adaptively adjust a parameter according to actual requirements.

In a third aspect, the present disclosure further provides an electrode sheet including the preceding composite current collector or the composite current collector prepared by the preceding preparation method. It is to be noted that the electrode sheet of the present disclosure may be, for example, obtained as follows: a positive electrode active material/negative electrode active material, a conductive agent, a binder, and a solvent are mixed into a slurry, and the slurry is coated on the composite current collector of the present application by a method for preparing the electrode sheet, which is well-known to those skilled in the art. According to different active materials, electrode sheets may be divided into a positive electrode sheet and a negative electrode sheet. The method for preparing the electrode sheet is not particularly limited in the present disclosure, which may be a preparation method well-known to those skilled in the art. The electrode sheet may be the positive electrode sheet or the negative electrode sheet.

The present disclosure further provides a battery including the composite current collector of the first aspect. The battery may comprise, for example, a positive electrode sheet, a negative electrode sheet, an electrolyte, and a separator. The separator is disposed between the positive electrode sheet and the negative electrode sheet to mainly prevent a short circuit between positive and negative electrodes and allow ions to pass through. The electrolyte conducts ions between the positive electrode sheet and the negative electrode sheet. In a charge discharge process of the battery, lithium ions shuttle between the positive electrode sheet and the negative electrode sheet, intercalating into and deintercalating from the positive electrode sheet and the negative electrode sheet. The positive electrode sheet and/or the negative electrode sheet may adopt the electrode sheet of the present disclosure.

The battery of the present disclosure includes a lithium-ion battery and/or a sodium-ion battery. Other materials, structures, and preparation methods than the composite current collector of the present disclosure are all selected from the conventional art.

Optionally, the composite current collector is used in the electrode sheet of the battery.

The composite current collector of the present disclosure may be used in the positive electrode sheet or the negative electrode sheet, which may be adaptively selected by those skilled in the art as required.

Another embodiment of the present disclosure further provides an electric device including the preceding battery. The battery may be used as a power supply or an energy storage unit in the electric device, and the electric device includes, but is not limited to, an electric vehicle, a smart home appliance, a computer, a tablet, a mobile phone, or a digital camera.

Compared with the related art, the present disclosure has the beneficial effects below.

According to the composite current collector structure of the present disclosure, through the collaboration of various structural layers in the functional layer, during the needle puncture process, the conductive layer generates the microcracks and the microcracks propagate rapidly to cause the large-area fractures so that the conductive layer is separated from the steel needle, thereby avoiding the closed loop due to the conduction between the positive and negative current collectors and the resulting thermal runaway of the battery, improving the safety of the battery, and facilitating the promotion and application of the composite current collector.

Other aspects can be understood after the drawings and the detailed description are read and understood.

### BRIEF DESCRIPTION OF DRAWINGS

The drawings are used to provide a further understanding of technical solutions herein, constitute part of the specification, and explain the technical solutions herein in conjunction with embodiments of the present application and are not intended to limit the technical solutions herein.

FIG. 1 is a structural diagram of a composite current collector according to Example 1, where 1 represents a base film, 2 represents an adhesive layer, 3 represents a conductive layer, and 4 represents a protective layer.

FIG. 2 is an image showing the overall morphology of a composite current collector prepared in Example 32.

FIG. 3 is an image showing the local morphology of a composite current collector prepared in Example 32. Additionally, elemental surface scanning was performed on the composite current collector in FIG. 3, and test results show that aluminum oxide (a metal oxide layer) and aluminum (a metal layer) are alternately stacked in the composite current collector in FIG. 3.

FIG. 4 shows X-ray diffraction spectra of a composite copper layer and an amorphous copper layer prepared in a specific embodiment of the present disclosure.

### DETAILED DESCRIPTION

Technical solutions of the present disclosure are further described below through specific examples. It is to be understood by those skilled in the art that the examples are intended to facilitate understanding of the present disclosure and are not to be construed as limiting the present disclosure.

In a specific embodiment, the present disclosure provides a preparation method for a composite current collector. The preparation method comprises the steps below.

(1) A base film is placed in a magnetron sputtering machine, a material of an adhesive layer is used as a target material, power, a gas flowrate, a vacuum degree, and a period during sputtering are adjusted, and the adhesive layer is deposited on a surface of the base film.

(2) A conductive layer is composited on a surface of the adhesive layer according to a stacking sequence of the conductive layer (that is, the number of metal layers, the number of intermediate layers, and an alternating sequence of the metal layers and the intermediate layers).

The preparation of a metal layer includes the following methods.

a. Evaporation method: The conditions for preparing the metal layer are as follows: a raw material is a high-purity metal wire (purity ≥99.9%), a heating temperature is higher than a melting point of the metal wire, a vacuum degree of a vacuum chamber is less than or equal to 0.1 Pa and optionally less than or equal to 0.05 Pa, a period for each coating is 0.5-100 s and optionally 0.5-40 s, and a main roller cooling temperature is −30 °C to 10 °C.

b. Magnetron sputtering method: For magnetron sputtering, the conditions for preparing the metal layer are as follows: a target material is a material of the metal layer (purity ≥99.9%), a power supply for the target material is a direct current power supply, target power is 5-20 KW, a vacuum degree of a vacuum chamber is less than or equal to 0.1 Pa, a gas source is argon, a flowrate of argon is 10-500 mL/min and optionally 20-500 mL/min, a period for each coating is 0.1-120 s and optionally 1-60 s, and a main roller cooling temperature is −20 °C to 30 °C.

c. Electroplating method: Specific process parameters of the electroplating method include the following: an average cathode current density is 1-3 A/dm² and may be, for example, 1 A/dm², 2 A/dm², or 3 A/dm², a plating solution temperature is 15-35 °C and may be, for example, 15 °C, 20 °C, 25 °C, 30 °C, or 35 °C, and an electroplating time is 1-90 s and may be, for example, 1 s, 10 s, 30 s, 60 s, or 90 s.

The preparation of intermediate layer(s) includes the following methods.

a. Magnetron sputtering method: A target material is a high-purity target material (purity ≥99.9%), such as the preceding alloy, nitride, sulfide, fluoride, silicide, or the phosphide; target power of a target power supply is 1-10 KW, a vacuum degree of a vacuum chamber is less than or equal to 0.1 Pa, a gas source is argon, a flowrate of argon is 10-500 mL/min, and a period for each coating is 0.1-30 s and optionally 0.5-10 s.

b. Evaporation method: Specific process parameters of the evaporation method include the following: a heating evaporation temperature is 1400-1600 °C and may be, for example, 1400 °C, 1500 °C, or 1600 °C, a coating vacuum degree is <0.1 Pa and may be, for example, 0.08 Pa, 0.06 Pa, or 0.04 Pa, a main roller cooling temperature during coating is −30 °C to −10 °C and may be, for example, −30 °C, −20 °C, or −10 °C, and a coating time is 0.1-10 s and may be, for example, 0.1 s, 1 s, 5 s, or 10 s.

(3) A protective layer is composited on a surface of the conductive layer.

The following examples and comparative examples were all prepared by the preceding preparation method.

### Example 1

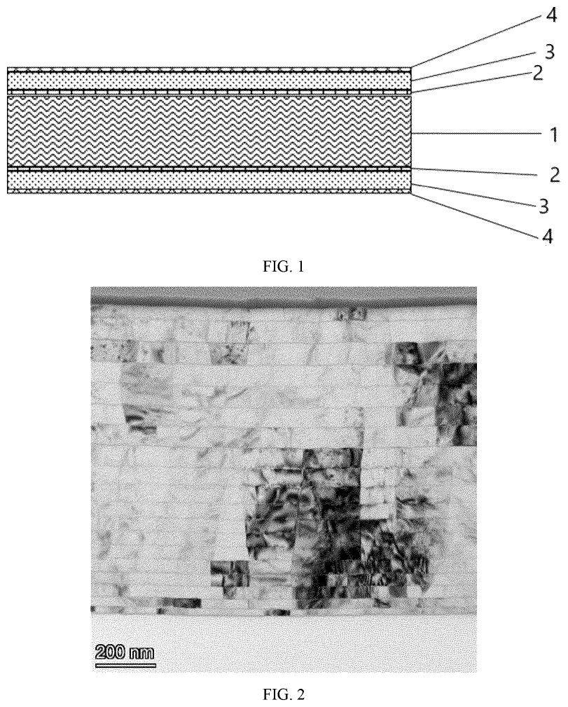

This example provides a composite current collector. As shown in FIG. 1, the composite current collector comprised a base film 1 (PET film) and functional layers located on two sides of the base film 1 (that is, the functional layers are disposed on the two sides of the base film); along a direction from the proximity of the base film 1 to a distance from the base film 1, each functional layer included an adhesive layer 2 (nickel-chromium alloy), a conductive layer 3 (with a thickness of 1030 nm), and a protective layer 4 (copper chromium oxide) stacked in sequence; and the conductive layer 3 included metal layers (copper) and intermediate layers (nickel-chromium-copper layer) stacked alternately, where the number of metal layers was 9 and the number of intermediate layers was 8, that is, metal layers in the conductive layer 4 were in direct contact with the adhesive layers and the protective layers.

The composite current collector was prepared by the following method based on the preparation method of the preceding embodiment.

(1) Preparation of the adhesive layer: a biaxially stretched PET film with a thickness of 6 μm was placed in a magnetron sputtering machine, and with a nickel-chromium alloy target as a target material, one adhesive layer 5 nm thick was deposited on each of two surfaces of the PET film under the following specific process conditions: the nickel-chromium target (with a purity of 99.99%) was used as the target material, target power was 5.0 kW, a flowrate of argon was 50 mL/min, a coating vacuum degree was 0.08 Pa, and a coating time was 1 s, so that a PET composite film with adhesive layers on the surfaces was prepared.

(2) Preparation of the conductive layer (with the metal layer(s) and the intermediate layer(s) arranged alternately): the prepared PET composite film with the adhesive layers on the surfaces was placed in a magnetron sputtering machine, and copper and nickel-chromium-copper were deposited in sequence on a surface of the composite film, where \textcircled{1} the metal layer was a copper layer with a thickness of 110 nm, the number of metal layers was 9, an average size of copper grains in the metal layer was 30 nm, and each layer was prepared under the following conditions: a copper target (with a purity of 99.99%) was used as a target material, target power was 12.0 KW, a flowrate of argon was 50 mL/min, a coating vacuum degree was 0.08 Pa, a main roller cooling temperature during coating was −10 °C, and a coating time was 11 s; \textcircled{2} the intermediate layer(s) were the nickel-chromium-copper layer with a thickness of 5 nm, the number of intermediate layers was 8, and each layer was prepared under the following conditions: a nickel-chromium-copper target (with a purity of 99.99%) was used as a target material, target power was 4.5 kW, a flowrate of argon was 50 mL/min, a coating vacuum degree was 0.08 Pa, a main roller cooling temperature during coating was −20 °C, and a coating time was 1 s, so that a PET composite film including the adhesive layers and conductive layers was prepared.

(3) Preparation of the protective layer: the prepared PET composite film including the adhesive layers and the conductive layers was immersed in a 0.5 g/L chromic anhydride aqueous solution (25 °C) for 20 s, washed in a pure water tank, and dried in a 60 °C oven, so that a finished composite current collector was obtained. The adhesion strength between the conductive layer and the base film in the prepared composite current collector was 500 N/m.

### Example 2

This example differs from Example 1 in that the intermediate layer(s) in this example were made of aluminum nitride. A preparation process of the intermediate layer(s) was as follows: an aluminum nitride target (with a purity of 99.99%) was used as the target material, the target power was 6.0 kW, the flowrate of argon was 50 mL/min, the coating vacuum degree was 0.08 Pa, the coating time was 1 s, and the main roller cooling temperature during coating was −20 °C.

The other structures and preparation processes thereof were consistent with those of Example 1.

### Example 3

This example differs from Example 1 in that the intermediate layer(s) in this example were made of chromium carbide. A preparation process of the intermediate layer(s) was as follows: a chromium carbide target (with a purity of 99.99%) was used as the target material, the target power was 5.6 kW, the flowrate of argon was 50 mL/min, the coating vacuum degree was 0.08 Pa, the coating time was 1 s, and the main roller cooling temperature during coating was −20 °C.

The other structures and preparation processes thereof were consistent with those of Example 1.

### Example 4

This example differs from Example 1 in that the intermediate layer(s) in this example were made of magnesium fluoride. A preparation process of the intermediate layer(s) was as follows: a magnesium fluoride target (with a purity of 99.99%) was used as the target material, the target power was 6.5 kW, the flowrate of argon was 50 mL/min, the coating vacuum degree was 0.08 Pa, the coating time was 1 s, and the main roller cooling temperature during coating was −20 °C.

The other structures and preparation processes thereof were consistent with those of Example 1.

### Example 5

This example differs from Example 1 in that the intermediate layer(s) in this example were made of nickel silicide. A preparation process of the intermediate layer(s) was as follows: a nickel silicide target (with a purity of 99.99%) was used as the target material, the target power was 5.8 kW, the flowrate of argon was 50 mL/min, the coating vacuum degree was 0.08 Pa, the coating time was 1 s, and the main roller cooling temperature during coating was −20 °C.

The other structures and preparation processes thereof were consistent with those of Example 1.

### Example 6

This example differs from Example 1 in that the intermediate layer(s) in this example were made of aluminum phosphide. A preparation process of the intermediate layer(s) was as follows: an aluminum phosphide target (with a purity of 99.99%) was used as the target material, the target power was 7.0 kW, the flowrate of argon was 50 mL/min, the coating vacuum degree was 0.08 Pa, the coating time was 1 s, and the main roller cooling temperature during coating was −20 °C.

The other structures and preparation processes thereof were consistent with those of Example 1.

### Example 7

This example differs from Example 1 in that the intermediate layer(s) in this example were made of a mixture of nickel-chromium-copper and aluminum nitride.

A preparation process of the intermediate layer(s) was as follows: a mixture target of nickel-chromium-copper and aluminum nitride (with a purity of 99.99%) was used as the target material, the target power was 5.0 kW, the flowrate of argon was 50 mL/min, the coating vacuum degree was 0.08 Pa, the coating time was 1 s, and the main roller cooling temperature during coating was −20 °C.

The other structures and preparation processes thereof were consistent with those of Example 1.

### Example 8

This example differs from Example 1 in that the intermediate layer(s) in this example were made of a mixture of magnesium fluoride and chromium carbide.

A preparation process of the intermediate layer(s) was as follows: a mixture target of magnesium fluoride and chromium carbide (with a purity of 99.99%) was used as the target material, the target power was 6.2 KW, the flowrate of argon was 50 mL/min, the coating vacuum degree was 0.08 Pa, the coating time was 1 s, and the main roller cooling temperature during coating was −20 °C.

The other structures and preparation processes thereof were consistent with those of Example 1.

### Example 9

This example differs from Example 1 in that the intermediate layer(s) in this example were made of a mixture of aluminum nitride and chromium carbide.

A preparation process of the intermediate layer(s) was as follows: a mixture target of aluminum nitride and chromium carbide (with a purity of 99.99%) was used as the target material, the target power was 6.0 kW, the flowrate of argon was 50 mL/min, the coating vacuum degree was 0.08 Pa, the coating time was 1 s, and the main roller cooling temperature during coating was −20 °C.

The other structures and preparation processes thereof were consistent with those of Example 1.

### Example 10

This example differs from Example 1 in that the metal layer(s) in this example were made of metal aluminum.

A preparation process of the metal layer(s) was as follows: an aluminum target (with a purity of 99.99%) was used as the target material, the target power was 10.0 KW, the flowrate of argon was 50 mL/min, the coating vacuum degree was 0.08 Pa, the coating time was 10 s, and the main roller cooling temperature during coating was −10 °C.

The other structures and preparation processes thereof were consistent with those of Example 1.

### Example 11

This example differs from Example 1 in that the metal layer(s) had a thickness of 60 nm and the conductive layer(s) had a thickness of 580 nm in this example.

A preparation process of the metal layer(s) was as follows: the copper target (with a purity of 99.99%) was used as the target material, the target power was 12 kW, the flowrate of argon was 50 mL/min, the coating vacuum degree was 0.08 Pa, the coating time was 6 s, and the main roller cooling temperature during coating was −10 °C.

The other structures and preparation processes thereof were consistent with those of Example 1.

### Example 12

This example differs from Example 1 in that the metal layer(s) had a thickness of 200 nm and the conductive layer(s) had a thickness of 1840 nm in this example.

A preparation process of the metal layer(s) were as follows: the copper target (with a purity of 99.99%) was used as the target material, the target power was 12 kW, the flowrate of argon was 50 mL/min, the coating vacuum degree was 0.08 Pa, the coating time was 20 s, and the main roller cooling temperature during coating was −10 °C.

The other structures and preparation processes thereof were consistent with those of Example 1.

### Example 13

This example differs from Example 1 in that the metal layer(s) had a thickness of 220 nm, the number of metal layers was 5, the number of intermediate layers was 4, and the conductive layer had a thickness of 1120 nm in this example.

A preparation process of the metal layer(s) was as follows: the copper target (with a purity of 99.99%) was used as the target material, the target power was 12 kW, the flowrate of argon was 50 mL/min, the coating vacuum degree was 0.08 Pa, the coating time was 22 s, and the main roller cooling temperature during coating was −10 °C.

The other structures and preparation processes thereof were consistent with those of Example 1.

### Example 14

This example differs from Example 1 in that an average grain size of metal grains in the metal layer(s) in this example was 100 nm.

A preparation process of the metal layer(s) was as follows: the copper target (with a purity of 99.99%) was used as the target material, the target power was 10.0 kW, the flowrate of argon was 50 mL/min, the coating vacuum degree was 0.08 Pa, the coating time was 14 s, and the main roller cooling temperature during coating was 1 °C.

The other structures and preparation processes thereof were consistent with those of Example 1.

### Example 15

This example differs from Example 1 in that an average grain size of metal grains in the metal layer(s) in this example was 200 nm.

A preparation process of the metal layer(s) was as follows: the copper target (with a purity of 99.99%) was used as the target material, the target power was 8.0 KW, the flowrate of argon was 50 mL/min, the coating vacuum degree was 0.08 Pa, the coating time was 17 s, and the main roller cooling temperature during coating was 10 °C.

The other structures and preparation processes thereof were consistent with those of Example 1.

### Example 16

This example differs from Example 1 in that an average grain size of metal grains in the metal layer(s) in this example was 220 nm.

A preparation process of the metal layer(s) was as follows: the copper target (with a purity of 99.99%) was used as the target material, the target power was 7.0 kW, the flowrate of argon was 50 mL/min, the coating vacuum degree was 0.08 Pa, the coating time was 19 s, and the main roller cooling temperature during coating was 12 °C.

The other structures and preparation processes thereof were consistent with those of Example 1.

### Example 17

This example differs from Example 1 in that in the conductive layer of this example, the number of intermediate layers was 9 and the number of metal layers was 8, that is, intermediate layers in the conductive layer were in direct contact with the adhesive layer and the protective layer, and the conductive layer has a thickness of 925 nm.

In the preparation process, the intermediate layer was first deposited on a surface of the adhesive layer. The other structures and preparation processes thereof were consistent with those of Example 1.

### Example 18

This example differs from Example 1 in that in the conductive layer of this example, the number of metal layers was 5 and the number of intermediate layers was 4, and the conductive layer had a thickness of 570 nm.

The other structures and preparation processes thereof were consistent with those of Example 1.

### Example 19

This example differs from Example 11 in that in the conductive layer of this example, the number of metal layers was 20, the metal layers had a thickness of 60 nm, the number of intermediate layers was 19, the intermediate layer had a thickness of 5 nm, and the conductive layer had a thickness of 1295 nm.

The other structures and preparation processes thereof were consistent with those of Example 11.

### Example 20

This example differs from Example 1 in that in the conductive layer of this example, the number of metal layers was 40, the number of intermediate layers was 39, the metal layers had a thickness of 20 nm, the intermediate layers had a thickness of 2 nm, and the conductive layer had a thickness of 878 nm.

The metal layer(s) was prepared under the following conditions: the copper target (with a purity of 99.99%) was used as the target material, the target power was 12.0 KW, the flowrate of argon was 50 mL/min, the coating vacuum degree was 0.08 Pa, the coating time was 2.0 s, and the main roller temperature during coating was −10 °C.

The intermediate layer was prepared under the following conditions: the nickel-chromium-copper target (with a purity of 99.99%) was used as the target material, the target power was 2.0 kW, the flowrate of argon was 50 mL/min, the coating vacuum degree was 0.08 Pa, the main roller cooling temperature during coating was −10 °C, and the coating time was 1 s, so that the PET composite film including the adhesive layers and the conductive layers was prepared.

The other structures and preparation processes thereof were consistent with those of Example 1.

### Example 21

This example differs from Example 20 in that in the conductive layer of this example, the number of metal layers was 45 and the number of intermediate layers was 44, and the conductive layer had a thickness of 988 nm.

The other structures and preparation processes thereof were consistent with those of Example 20.

### Example 22

This example differs from Example 12 in that in the conductive layer of this example, the number of metal layers was 4 and the number of intermediate layers was 3, and the conductive layer had a thickness of 815 nm.

The other structures and preparation processes thereof were consistent with those of Example 12.

### Example 23

This example differs from Example 1 in that in the conductive layer of this example, the intermediate layers had a thickness of 0.5 nm.

A preparation process of the intermediate layer was as follows: the nickel-chromium-copper target (with a purity of 99.99%) was used as the target material, the target power was 2.0 KW, the flowrate of argon was 50 mL/min, the coating vacuum degree was 0.08 Pa, the coating time was 0.25 s, and the main roller cooling temperature during coating was −20 °C.

The other structures and preparation processes thereof were consistent with those of Example 1.

### Example 24

This example differs from Example 1 in that in the conductive layer of this example, the intermediate layers had a thickness of 1 nm. A preparation process of the intermediate layer was as follows: the nickel-chromium-copper target (with a purity of 99.99%) was used as the target material, the target power was 2.0 kW, the flowrate of argon was 50 mL/min, the coating vacuum degree was 0.08 Pa, the coating time was 0.5 s, and the main roller cooling temperature during coating was −20 °C.

The other structures and preparation processes thereof were consistent with those of Example 1.

### Example 25

This example differs from Example 1 in that in the conductive layer of this example, the intermediate layers had a thickness of 10 nm.

A preparation process of the intermediate layer was as follows: the nickel-chromium-copper target (with a purity of 99.99%) was used as the target material, the target power was 4.5 kW, the flowrate of argon was 50 mL/min, the coating vacuum degree was 0.08 Pa, the coating time was 2 s, and the main roller cooling temperature during coating was −20 °C.

The other structures and preparation processes thereof were consistent with those of Example 1.

### Example 26

This example differs from Example 1 in that the adhesive layer in this example was made of titanium.

A preparation process of the adhesive layer was as follows: a titanium target (with a purity of 99.99%) was used as the target material, the target power was 4.8 kW, the flowrate of argon was 50 mL/min, the coating vacuum degree was 0.08 Pa, the coating time was 1 s, and the main roller cooling temperature during coating was −20 °C. The adhesion strength between the conductive layer and the base film in the prepared composite current collector was 100 N/m. The other structures and preparation processes thereof were consistent with those of Example 1.

### Example 27

This example differs from Example 1 in that the adhesive layer in this example was made of silicon oxide.

A preparation process of the adhesive layer was as follows: a silicon oxide target (with a purity of 99.99%) was used as the target material, the target power was 6 KW, the flowrate of argon was 50 mL/min, the coating vacuum degree was 0.08 Pa, the coating time was 1 s, and the main roller cooling temperature during coating was −20 °C. The adhesion strength between the conductive layer and the base film in the prepared composite current collector was 900 N/m.

The other structures and preparation processes thereof were consistent with those of Example 1.

### Example 28

This example differs from Example 1 in that a porous PET film (with an average pore size of 0.2 microns) was used in this example, and the adhesion strength between the conductive layer and the base film in the prepared composite current collector was 1000 N/m.

The other structures and preparation processes thereof were consistent with those of Example 1.

### Example 29

This example differs from Example 1 in that the functional layer was located on one surface of the base film in this example.

The other structures and preparation processes thereof were consistent with those of Example 1.

### Example 30

This example differs from Example 1 in that no adhesive layer was provided in this comparative example, and the adhesion strength between the conductive layer and the base film was 50 N/m.

The other structures and preparation processes thereof were consistent with those of Example 1.

### Example 31

A composite current collector was prepared by the method below.

A biaxially stretched PET film with a thickness of 6 μm was placed in a vacuum evaporator, and metal oxide layers and aluminum metal layers were alternately deposited on two sides of the biaxially stretched PET film in a thickness direction under the specific process conditions described below.

(a) An aluminum metal layer was prepared: a raw material was a high-purity aluminum wire (with a purity of 99.93%), a heating temperature was 1200 °C, a vacuum degree of a vacuum chamber was 0.1 Pa, and a period for each deposition was 20 s.

(b) A metal oxide layer was prepared: a raw material was a high-purity metal wire (with a purity of 99.93%), and during evaporation, a heating temperature was higher than a melting point of the metal wire, a gas source was oxygen with a flowrate of 100 mL/min, a vacuum degree of a vacuum chamber was 0.3 Pa, and a period for each deposition was 0.3 s.

The multi-layer composite current collector was prepared according to the preceding process conditions, where two aluminum metal layers and three aluminum oxide layers (metal oxide layers) were disposed on each of the two sides of the PET film in the thickness direction, a structure in which the metal oxide layer, the aluminum metal layer, the metal oxide layer, the aluminum metal layer, and the metal oxide layer were stacked in sequence was disposed on one side of the PET film in the thickness direction, each aluminum metal layer had a thickness of 500 nm, and each metal oxide layer had a thickness of 5 nm.

### Example 32

The composite current collector in this example was prepared by the same method as Example 31, except that among the process conditions (a) for preparing the aluminum metal layer, the period for each deposition was 2.1 s; in the prepared composite current collector, 19 aluminum metal layers and 20 aluminum oxide layers were disposed on each of the two sides of the PET film in the thickness direction, and each aluminum metal layer had a thickness of 53 nm.

### Example 33

The composite current collector in this example was prepared by the same method as Example 31, except that among the process conditions (a) for preparing the aluminum metal layer, the period for each deposition was 0.8 s; among the process conditions (b) for preparing the metal oxide layer, the period for each deposition was 0.1 s; in the prepared composite current collector, 50 aluminum metal layers and 51 aluminum oxide layers were disposed on each of the two sides of the PET film in the thickness direction, each aluminum metal layer had a thickness of 20 nm, and each metal oxide layer had a thickness of 1.9 nm.

### Example 34

A composite current collector was prepared by the method below.

A biaxially stretched PET film with a thickness of 6 μm was placed in a vacuum evaporator, and metal oxide layers and aluminum metal layers were alternately deposited on two sides of the biaxially stretched PET film in a thickness direction under the specific process conditions described below.

(a) An aluminum metal layer was prepared: a raw material was a high-purity aluminum wire (with a purity of 99.93%), a heating temperature was 1200 °C, a vacuum degree of a vacuum chamber was 0.1 Pa, and a period for each deposition was 2.1 s.

(b) A metal oxide layer was prepared: a target material was silicon oxide (with a purity of 99.95%), a power supply for the target material was a direct current power supply, a power density was 50 W/cm², a vacuum degree of a vacuum chamber was 0.1 Pa, a gas source was argon, a flowrate of argon was 60 mL/min, and a period for each deposition was 1.0 s.

The multi-layer composite current collector was prepared according to the preceding process conditions, where 19 aluminum metal layers and 20 silicon oxide layers (metal oxide layers) were disposed on each of the two sides of the PET film in the thickness direction, each aluminum metal layer had a thickness of 53 nm, and each metal oxide layer had a thickness of 5 nm.

### Example 35

A composite current collector was prepared by the method below.

A biaxially stretched PET film with a thickness of 6 μm was placed in a vacuum evaporator, and metal oxide layers and aluminum metal layers were alternately deposited on two sides of the biaxially stretched PET film in a thickness direction under the specific process conditions described below.

(a) An aluminum metal layer was prepared: a raw material was a high-purity aluminum wire (with a purity of 99.93%), a heating temperature was 1200 °C, a vacuum degree of a vacuum chamber was 0.1 Pa, and a period for each deposition was 2.1 s.

(b) A metal oxide layer was prepared: a target material was titanium oxide (with a purity of 99.95%), a power supply for the target material was a direct current power supply, a power density was 50 W/cm², a vacuum degree of a vacuum chamber was 0.1 Pa, a gas source was argon, a flowrate of argon was 60 mL/min, and a period for each deposition was 1.2 s.

The multi-layer composite current collector was prepared according to the preceding process conditions, where 19 aluminum metal layers and 20 titanium oxide layers (metal oxide layers) were disposed on each of the two sides of the PET film in the thickness direction, each aluminum metal layer had a thickness of 53 nm, and each metal oxide layer had a thickness of 5 nm.

### Example 36

A composite current collector was prepared by the method below.

A biaxially stretched PET film with a thickness of 6 μm was placed in a vacuum evaporator, and metal oxide layers and aluminum metal layers were alternately deposited on two sides of the biaxially stretched PET film in a thickness direction under the specific process conditions described below.

(a) Preparation of an aluminum metal layer: a raw material was a high-purity aluminum wire (with a purity of 99.93%), a heating temperature was 1200 °C, a vacuum degree of a vacuum chamber was 0.1 Pa, and a period for each deposition was 2.1 s.

(b) A metal oxide layer was prepared: a target material was copper oxide (with a purity of 99.95%), a power supply for the target material was a direct current power supply, a power density was 50 W/cm², a vacuum degree of a vacuum chamber was 0.1 Pa, a gas source was argon, a flowrate of argon was 60 mL/min, and a period for each deposition was 1.5 s.

The multi-layer composite current collector was prepared according to the preceding process conditions, where 19 aluminum metal layers and 20 copper oxide layers (metal oxide layers) were disposed on each of the two sides of the PET film in the thickness direction, each aluminum metal layer had a thickness of 53 nm, and each metal oxide layer had a thickness of 5 nm.

### Example 37

A composite current collector was prepared by the method below.

A biaxially stretched PET film with a thickness of 6 μm was placed in a vacuum evaporator, and metal oxide layers and aluminum metal layers were alternately deposited on two sides of the biaxially stretched PET film in a thickness direction under the specific process conditions described below.

(a) An aluminum metal layer was prepared: a raw material was a high-purity aluminum wire (with a purity of 99.93%), a heating temperature was 1200 °C, a vacuum degree of a vacuum chamber was 0.1 Pa, and a period for each deposition was 2.1 s.

(b) A metal oxide layer was prepared: a target material was nickel oxide (with a purity of 99.95%), a power supply for the target material was a direct current power supply, a power density was 50 W/cm², a vacuum degree of a vacuum chamber was 0.1 Pa, a gas source was argon, a flowrate of argon was 60 mL/min, and a period for each deposition was 1.3 s.

The multi-layer composite current collector was prepared according to the preceding process conditions, where 19 aluminum metal layers and 20 copper oxide layers (metal oxide layers) were disposed on each of the two sides of the PET film in the thickness direction, each aluminum metal layer had a thickness of 53 nm, and each metal oxide layer had a thickness of 5 nm.

### Example 38

The composite current collector in this example was prepared by the same method as Example 31, except that the PET film was replaced with a PEN film.

### Example 39

The composite current collector in this example was prepared by the same method as Example 31, except that the PET film was replaced with a PP film.

### Example 40

The composite current collector in this example was prepared by the same method as Example 31, except that the PET film was replaced with a PPS film.

### Example 41

The composite current collector in this example was prepared by the same method as Example 31, except that among the process condition (a) for preparing the aluminum metal layer, the period for each deposition was 10 s; in the prepared composite current collector, each aluminum metal layer had a thickness of 250 nm.

### Example 42

The composite current collector in this example was prepared by the same method as Example 31, except that among the process condition (a) for preparing the aluminum metal layer, the period for each deposition was 40 s; in the prepared composite current collector, each aluminum metal layer had a thickness of 1000 nm.

### Example 43

The composite current collector in this example was prepared by the same method as Example 31, except that among the process condition (a) for preparing the aluminum metal layer, the period for each deposition was &s; in the prepared composite current collector, each aluminum metal layer had a thickness of 200 nm.

### Example 44

The composite current collector in this example was prepared by the same method as Example 31, except that among the process condition (b) for preparing the metal oxide layer, the period for each deposition was 1.2 s; in the prepared composite current collector, each metal oxide layer had a thickness of 20 nm.

### Example 45

The composite current collector in this example was prepared by the same method as Example 31, except that among the process condition (b) for preparing the metal oxide layer, the period for each deposition was 2.0 s; in the prepared composite current collector, each metal oxide layer had a thickness of 33 am.

### Example 46

The composite current collector in this example was prepared by the same method as Example 31, except that among the process condition (b) for preparing the metal oxide layer, the period for each deposition was 2.4 s; in the prepared composite current collector, each metal oxide layer had a thickness of 40 nm.

### Example 47

The composite current collector in this example was prepared by the same method as Example 31, except that the composite current collector in this example had one aluminum metal layer and two aluminum oxide layers.

### Example 48

The composite current collector in this example was prepared by the same method as Example 31, except that the metal oxide layers and the aluminum metal layers were alternately deposited on one side of the biaxially stretched PET film in the thickness direction, the composite current collector had two aluminum metal layers and three aluminum oxide layers and was a structure in which the PET film, the metal oxide layer, the aluminum metal layer, the metal oxide layer, the aluminum metal layer, and the metal oxide layer were stacked in sequence, each aluminum metal layer had a thickness of 500 nm, and each metal oxide layer had a thickness of 5 nm.

### Example 49

The composite current collector in this example was prepared by the same method as Example 31, except that in the prepared multi-layer composite current collector, two aluminum metal layers and two aluminum oxide layers (metal oxide layers) were disposed on each of the two sides of the PET film in the thickness direction, a structure in which the aluminum metal layer, the metal oxide layer, the aluminum metal layer, and the metal oxide layer were stacked in sequence was disposed on one side of the PET film in the thickness direction, each aluminum metal layer had a thickness of 500 nm, and each metal oxide layer had a thickness of 5 nm

### Example 50

This example provides a composite copper current collector. The composite copper current collector includes: a polymer base film made of PET and having a thickness of 4.5 μm; adhesive layers disposed on two surfaces of the polymer base film and made of a nickel-chromium alloy, where a single layer had a thickness of 5 nm, and the adhesive layers included a first adhesive layer and a second adhesive layer; composite copper layers disposed on surfaces of the adhesive layers facing away from the polymer base film, where a single layer had a thickness of 750 nm, the composite copper layers included a first composite copper layer and a second composite copper layer, the composite copper layer was formed by amorphous copper layers and crystalline copper layers stacked alternately, an amorphous copper layer was located on a side of the composite copper layer adjacent to the adhesive layer, a crystalline copper layer was located on a side of the composite copper layer away from the adhesive layer, the number of amorphous copper layers was 5, each having a thickness of 50 nm, and the number of crystalline copper layers was 5, each having a thickness of 100 nm; and protective layers disposed on surfaces of the composite copper layers facing away from the polymer base film and made of carbon nanotubes, where a single layer had a thickness of 12 nm, and the protective layers included a first protective layer and a second protective layer.

This example further provides a preparation method for the composite copper current collector. The preparation method includes the steps below.

(1) A PET film was prepared by a melt-extrusion-biaxial stretching method.

(2) The PET film was placed in a magnetron sputtering machine, and one adhesive layer was deposited on each of the two surfaces of the PET film under the following specific process conditions: a nickel-chromium target (with a purity of 99.99%) was used as a target material, target power was 5.0 kW, a flowrate of argon was 50 mL/min, a coating vacuum degree was 0.08 Pa, a coating time was 1 s, and a main roller temperature during coating was 0 °C so that a PET composite film with the adhesive layers on the surfaces was obtained.

(3) The PET composite film with the adhesive layers on the surfaces was placed in a magnetron sputtering machine, and the amorphous copper layers and the crystalline copper layers were alternately deposited on each of two surfaces of the composite film, so that a PET film including the composite copper layers and the adhesive layers was obtained, where \textcircled{1} the number of amorphous copper layers was 5, and each layer was prepared under the following process conditions: a copper target (with a purity of 99.99%) was used as a target material, target power was 5 kW, a gas source was argon, a flowrate of argon was 60 mL/min, a coating vacuum degree was 0.09 Pa, a coating time was 15 s, and a main roller cooling temperature during coating was-30 °C; \textcircled{2} the number of crystalline copper layers was 5, and each layer was prepared under the following process conditions: components of an electroplating solution included 100 g/L copper sulfate, 120 g/L sulfuric acid, 50 mg/L chloride ions, 10 ppm bis-(sodium sulfopropyl)-disulfide, 2 ppm N,N-diethylthiourea, and 100 ppm polyoxyethylene ether, an average cathode current density was 1.7 A/dm², a plating solution temperature was 25 °C, and an electroplating time was 30 s.

(4) 1.5 g of carbon nanotubes were uniformly dispersed in 998.5 g of N-methylpyrrolidone (NMP) solution through ultrasonic dispersion to prepare a coating solution with a solid content of 0.15 wt. %, and the coating solution was uniformly coated on surfaces of the PET film including the composite copper layers and the adhesive layers by a die coating process and dried at 100 °C to obtain the protective layer with a thickness of 12 nm, so that the composite copper current collector was obtained.

Additionally, to prove that the composite copper layer in this example was a stacked structure of the amorphous copper layers and the crystalline copper layers, two samples were prepared by the preparation methods of this example, that is, one amorphous copper layer was prepared on a surface of the PET film by the preparation method for amorphous copper in this example to obtain sample 1; and one crystalline copper layer was prepared on a surface of sample 1 by the preparation method for crystalline copper in this example to obtain sample 2. Then, according to requirements of an X-ray diffractometer, the samples were prepared and placed in the X-ray diffractometer (Bruker D8 ADVANCE), with copper as a target material, a scanning speed being 2.0000 deg/min, and a scanning range being 30° to 80°. The test results are shown in FIG. 4. As can be seen from the figure, no diffraction peak of copper was found in a diffraction spectrum of sample 1, while diffraction peaks of crystal plane orientations (111), (200), and (220) of copper were found in sample 2, indicating that the amorphous copper layers and the crystalline copper layers can be prepared by the preparation methods of this example, that is, the composite copper layer prepared in this example is a stacked structure of the amorphous copper layers and the crystalline copper layers.

### Example 51

This example differs from Example 50 in that the amorphous copper layer had a thickness of 20 nm, and each layer was prepared under the following process conditions: the copper target (with a purity of 99.99%) was used as the target material, the target power was 5 kW, the gas source was argon, the flowrate of argon was 60 mL/min, the coating vacuum degree was 0.09 Pa, the coating time was 6 s, and the main roller cooling temperature during coating was −30 °C.

The remaining preparation methods and parameters were consistent with those of Example 50.

### Example 52

This example differs from Example 50 in that the amorphous copper layer had a thickness of 80 nm, and each layer was prepared under the following process conditions; the copper target (with a purity of 99.99%) was used as the target material, the target power was 5 kW, the gas source was argon, the flowrate of argon was 60 mL/min, the coating vacuum degree was 0.09 Pa, the coating time was 24 s, and the main roller cooling temperature during coating was −30 °C.

The remaining preparation methods and parameters were consistent with those of Example 50.

### Example 53

This example differs from Example 50 in that the amorphous copper layer had a thickness of 100 nm, and each layer was prepared under the following process conditions: the copper target (with a purity of 99.99%) was used as the target material, the target power was 5 kW, the gas source was argon, the flowrate of argon was 60 mL/min, the coating vacuum degree was 0.09 Pa, the coating time was 30 s, and the main roller cooling temperature during coating was −30 °C.

The remaining preparation methods and parameters were consistent with those of Example 50.

### Example 54

This example differs from Example 50 in that the crystalline copper layer had a thickness of 50 nm, and each layer was prepared under the following process conditions: the components of the electroplating solution included 100 g/L copper sulfate, 120 g/L sulfuric acid, 50 mg/L chloride ions, 10 ppm bis-(sodium sulfopropyl)-disulfide, 2 ppm N,N-diethylthiourea, and 100 ppm polyoxyethylene ether, the average cathode current density was 1.7 A/dm², the plating solution temperature was 25 °C, and the electroplating time was 158.

The remaining preparation methods and parameters were consistent with those of Example 50.

### Example 55

This example differs from Example 50 in that the crystalline copper layer had a thickness of 200 nm, and each layer was prepared under the following process conditions: the components of the electroplating solution included 100 g/L copper sulfate, 120 g/L sulfuric acid, 50 mg/L chloride ions, 10 ppm bis-(sodium sulfopropyl)-disulfide, 2 ppm N,N-diethylthiourea, and 100 ppm polyoxyethylene ether, the average cathode current density was 1.7 A/dm², the plating solution temperature was 25 °C, and the electroplating time was 60 s.

The remaining preparation methods and parameters were consistent with those of Example 50.

### Example 56

This example differs from Example 50 in that the crystalline copper layer had a thickness of 300 nm, and each layer was prepared under the following process conditions: the components of the electroplating solution included 100 g/L copper sulfate, 120 g/L sulfuric acid, 50 mg/L chloride ions, 10 ppm bis-(sodium sulfopropyl)-disulfide, 2 ppm N,N-diethylthiourea, and 100 ppm polyoxyethylene ether, the average cathode current density was 1.7 A/dm², the plating solution temperature was 25 °C, and the electroplating time was 90 s.

The remaining preparation methods and parameters were consistent with those of Example 50.

### Example 57

This example differs from Example 56 in that the number of amorphous copper layers and the number of crystalline copper layers were each 2.

The remaining preparation methods and parameters were consistent with those of Example 56.

### Example 58

This example differs from Example 50 in that the number of amorphous copper layers and the number of crystalline copper layers were each 10.

The remaining preparation methods and parameters were consistent with those of Example 50.

### Example 59

This example differs from Example 50 in that the amorphous copper layer was prepared through evaporation, and each layer was prepared under the following process conditions: a copper wire (with a purity of 99.99%) was used as a copper source, a heating evaporation temperature was 1500 °C, a coating vacuum degree was 0.05 Pa, a main roller cooling temperature during coating was −30 °C, and a coating time was 1.5 s.

The remaining preparation methods and parameters were consistent with those of Example 50.

### Example 60

This example differs from Example 50 in that the amorphous copper layer was prepared in two steps of magnetron sputtering and evaporation, and each layer was prepared under the following process conditions: \textcircled{1} amorphous copper 20 nm thick was prepared through the magnetron sputtering: the copper target (with a purity of 99.99%) was used as the target material, the target power was 5 KW, the gas source was argon, the flowrate of argon was 60 mL/min, the coating vacuum degree was 0.09 Pa, the coating time was 6 s, and the main roller temperature during coating was −30 °C; \textcircled{2} amorphous copper 30 nm thick was prepared through the evaporation: a copper wire (with a purity of 99.99%) was used as a copper source, a heating evaporation temperature was 1500 °C, a coating vacuum degree was 0.05 Pa, a main roller cooling temperature during coating was −30 °C, and a coating time was 0.9 s.

The remaining preparation methods and parameters were consistent with those of Example 50.

### Example 61

This example differs from Example 50 in that the number of amorphous copper layer(s) and the number of crystalline copper layer(s) were each 1, and in the conductive layer, the amorphous copper layer had a thickness of 100 nm and the crystalline copper layer had a thickness of 300 nm. The amorphous copper layer was prepared under the following process conditions: the copper target (with a purity of 99.99%) was used as the target material, the target power was 5 KW, the gas source was argon, the flowrate of argon was 60 mL/min, the coating vacuum degree was 0.09 Pa, the coating time was 30 s, and the main roller cooling temperature during coating was −30 °C. The crystalline copper layer was prepared under the following process conditions: the components of the electroplating solution included 100 g/L copper sulfate, 120 g/L sulfuric acid, 50 mg/L chloride ions, 10 ppm bis-(sodium sulfopropyl)-disulfide, 2 ppm N,N-diethylthiourea, and 100 ppm polyoxyethylene ether, the average cathode current density was 1.7 A/dm², the plating solution temperature was 25 °C, and the electroplating time was 90 s.

The remaining preparation methods and parameters were consistent with those of Example 50.

### Example 62

This example differs from Example 50 in that the amorphous copper layer had a thickness of 120 nm, and each layer was prepared under the following process conditions: the copper target (with a purity of 99.99%) was used as the target material, the target power was 5 kW, the gas source was argon, the flowrate of argon was 60 mL/min, the coating vacuum degree was 0.09 Pa, the coating time was 36 s, and the main roller cooling temperature during coating was −30 °C.

The remaining preparation methods and parameters were consistent with those of Example 50.

### Example 63

This example differs from Example 50 in that the crystalline copper layer had a thickness of 320 nm, and each layer was prepared under the following process conditions: the components of the electroplating solution included 100 g/L copper sulfate, 120 g/L sulfuric acid, 50 mg/L chloride ions, 10 ppm bis-(sodium sulfopropyl)-disulfide, 2 ppm N,N-diethylthiourea, and 100 ppm polyoxyethylene ether, the average cathode current density was 1,7 A/dm², the plating solution temperature was 25 °C, and the electroplating time was 96 s.

The remaining preparation methods and parameters were consistent with those of Example 50.

### Example 64

This example provides a composite current collector. The composite current collector included a polymer base film and composite conductive layers disposed on two surfaces of the polymer base film.

Each composite conductive layer included an intermediate layer and a metal layer stacked alternately, where the intermediate layer included a fluorocarbon material, and the fluorocarbon material was a fluorocarbon polymer.

A chemical composition of the fluorocarbon polymer was CₓF_{y}, where x/y=5, and a weight average molecular weight of the fluorocarbon polymer was 32000 Da.

The number of intermediate layers was 10, a single intermediate layer had a thickness of 5 nm, the number of metal layers was 10, the metal layer was made of copper, and a single metal layer had a thickness of 50 nm.

The composite conductive layer on one surface of the polymer base film had a thickness of 550 nm.

The polymer base film had a thickness of 4.5 μm and was made of PET.

Protective layers were provided on surfaces of the composite conductive layers facing away from the polymer base film, where a single protective layer had a thickness of 5 nm and was made of graphene.

The composite current collector had a thickness of 5.61 μm.

This example further provides a preparation method for the composite current collector. The preparation method includes the steps below.

(1) A PET film prepared by a melt-extrusion-biaxial stretching method was placed in a magnetron sputtering machine, and intermediate layers and copper layers were alternately deposited on each of two surfaces of the PET film, where the number of intermediate layers was 10 and the number of copper layers was 10, so that a PET composite film including the composite conductive layers was obtained.

A single intermediate layer was prepared according to the following process parameters: a graphite-polytetrafluoroethylene mixture target (where the mass ratio of graphite to polytetrafluoroethylene was 2.16:1) was used as a target material, target power was 3 kW, a flowrate of argon was 50 mL/min, a coating vacuum degree was 0.08 Pa, a coating time was 1 s, and a main roller temperature during coating was 0 °C.

A single copper layer was prepared according to the following process parameters: a copper target (with a purity of 99.99%) was used as a target material, target power was 12 kW, a flowrate of argon was 50 mL/min, a coating vacuum degree was 0.08 Pa, a coating time was 5 s, and a main roller temperature during coating was 2 °C.

(2) The prepared PET composite film was placed in a coating apparatus, a graphene solution with a solid content of 0.1 wt. % (with N-methylpyrrolidone as a solvent) was used as a coating solution and uniformly coated on two surfaces of the PET composite film by a die coating process and dried at 70 °C to obtain the protective layers each having a thickness of 5 nm, so that the composite current collector was obtained.

### Example 65

This example differs from Example 64 in that in the composite conductive layer, a single metal layer had a thickness of 100 nm, and the coating time among the process parameters for preparing a single layer was adjusted to 10 s.

The remaining preparation methods and parameters were consistent with those of Example 64.

### Example 66

This example differs from Example 64 in that in the composite conductive layer, a single metal layer had a thickness of 150 nm, and the coating time among the process parameters for preparing a single layer was adjusted to 15 s.

The remaining preparation methods and parameters were consistent with those of Example 64.

### Example 67

This example differs from Example 64 in that in the composite conductive layer, a single metal layer had a thickness of 200 nm, and the coating time among the process parameters for preparing a single layer was adjusted to 20 s.

The remaining preparation methods and parameters were consistent with those of Example 64.

### Example 68

This example differs from Example 65 in that in the composite conductive layer, a single intermediate layer had a thickness of 2 nm, and the coating time among the process parameters for preparing a single layer was adjusted to 0.48.

The remaining preparation methods and parameters were consistent with those of Example 65.

### Example 69

This example differs from Example 65 in that in the composite conductive layer, a single intermediate layer had a thickness of 20 nm, and the coating time among the process parameters for preparing a single layer was adjusted to 4 s.

The remaining preparation methods and parameters were consistent with those of Example 65.

### Example 70

This example differs from Example 65 in that in the composite conductive layer, a single intermediate layer had a thickness of 50 nm, and the coating time among the process parameters for preparing a single layer was adjusted to 10 s.

The remaining preparation methods and parameters were consistent with those of Example 65.

### Example 71

This example differs from Example 65 in that the number of intermediate layers and the number of metal layers were each 3, a single metal layer had a thickness of 200 nm, and the coating time among the process parameters for preparing a single layer was adjusted to 20 s.

The remaining preparation methods and parameters were consistent with those of Example 65.

### Example 72

This example differs from Example 65 in that the number of intermediate layers and the number of metal layers were each 5.

The remaining preparation methods and parameters were consistent with those of Example 65.

### Example 73

This example differs from Example 65 in that the number of intermediate layers and the number of metal layers were each 15.

The remaining preparation methods and parameters were consistent with those of Example 65.

### Example 74

This example differs from Example 64 in that the metal layer was made of aluminum, and among the process parameters for preparing a single layer, the target material was adjusted to an aluminum target with a purity of 99.99%, the target power was adjusted to 10 KW, the coating vacuum degree was adjusted to 0.07 Pa, and the main roller temperature during coating was adjusted to 0 °C.

The remaining preparation methods and parameters were consistent with those of Example 64.

### Example 75

This example differs from Example 64 in that the material of the polymer base film was adjusted to PP.

The remaining preparation methods and parameters were consistent with those of Example 64.

### Example 76

This example differs from Example 64 in that the chemical composition of the fluorocarbon polymer in the intermediate layer was CₓF_{y}, where x/y=0.6, and among the process parameters for preparing a single layer, the mass ratio of graphite to polytetrafluoroethylene in the target material was adjusted to 0.048:1, and the target power was adjusted to 5 KW.

The remaining preparation methods and parameters were consistent with those of Example 64.

### Example 77

This example differs from Example 64 in that the chemical composition of the fluorocarbon polymer in the intermediate layer was CₓF_{y}, where x/y=10, and among the process parameters for preparing a single layer, the mass ratio of graphite to polytetrafluoroethylene in the target material was adjusted to 4.56:1, and the target power was adjusted to 5 kW.

The remaining preparation methods and parameters were consistent with those of Example 64.

### Example 78

This example differs from Example 64 in that in the composite conductive layer, a single metal layer had a thickness of 220 nm, and the coating time among the process parameters for preparing a single layer was adjusted to 22 s.

The remaining preparation methods and parameters were consistent with those of Example 64.

### Example 79

This example differs from Example 65 in that in the composite conductive layer, a single intermediate layer had a thickness of 55 nm, and the coating time among the process parameters for preparing a single layer was adjusted to 11 s.

The remaining preparation methods and parameters were consistent with those of Example 65.

### Example 80

This example differs from Example 65 in that in the composite conductive layer, a single intermediate layer had a thickness of 1 nm, and the coating time among the process parameters for preparing a single layer was adjusted to 0.28.

The remaining preparation methods and parameters were consistent with those of Example 65.

### Example 81

This example differs from Example 65 in that the number of intermediate layers and the number of metal layers were each 16.

The remaining preparation methods and parameters were consistent with those of Example 65.

### Example 82

This example differs from Example 71 in that the number of intermediate layers and the number of metal layers were each 2.

The remaining preparation methods and parameters were consistent with those of Example 71.

### Example 83

This example differs from Example 64 in that the chemical composition of the fluorocarbon polymer in the intermediate layer was CₓF_{y}, where x/y=0.55, and among the process parameters for preparing a single layer, the mass ratio of graphite to polytetrafluoroethylene in the target material was adjusted to 0.024:1, and the target power was adjusted to 6 kW.

The remaining preparation methods and parameters were consistent with those of Example 64.

### Example 84

This example differs from Example 64 in that the chemical composition of the fluorocarbon polymer in the intermediate layer was CₓF_{y}, where x/y=11, and among the process parameters for preparing a single layer, the mass ratio of graphite to polytetrafluoroethylene in the target material was adjusted to 5.04:1, and the target power was adjusted to 6 kW.

The remaining preparation methods and parameters were consistent with those of Example 64.

### Comparative Example 1

This comparative example differs from Example 1 in that the conductive layer in this comparative example included no intermediate layer (that is, the conductive layer was a pure metal layer), and the metal layer had a thickness of 1030 nm.

A preparation process of the metal layer was as follows: the copper target (with a purity of 99.99%) was used as the target material, the target power was 12.0 kW, the flowrate of argon was 50 mL/min, the coating vacuum degree was 0.08 Pa, the coating time was 103 s, and the main roller temperature during coating was −10 °C. The other structures and preparation processes thereof were consistent with those of Example 1.

### Comparative Example 2

The composite current collector in Comparative Example 2 was prepared by the same method as Example 31, except that one aluminum metal layer was deposited on each of two sides of the biaxially stretched PET film in the thickness direction, a deposition time was 40 s, and the aluminum metal layer on one side of the PET film had a thickness of 1000 nm.

### Comparative Example 3

This comparative example differs from Example 50 in that the composite copper layer was a single copper layer prepared by the following process: the copper target (with a purity of 99.99%) was used as the target material, the target power was 12 kW, the flowrate of argon was 50 mL/min, the coating vacuum degree was 0.08 Pa, the coating time was 100 s, and the main roller temperature during coating was 2 °C.

The remaining preparation methods and parameters were consistent with those of Example 50.

### Comparative Example 4

This comparative example differs from Example 64 in that the composite conductive layer included no intermediate layer and included only a single metal layer with a thickness of 500 nm, and the coating time among the preparation process parameters was adjusted to 508.

The remaining preparation methods and parameters were consistent with those of Example 64.

### Comparative Example 5

This comparative example differs from Example 64 in that the intermediate layer was replaced with a carbon layer, and the target material among the process parameters for preparing a single layer was adjusted to graphite.

The remaining preparation methods and parameters were consistent with those of Example 64.

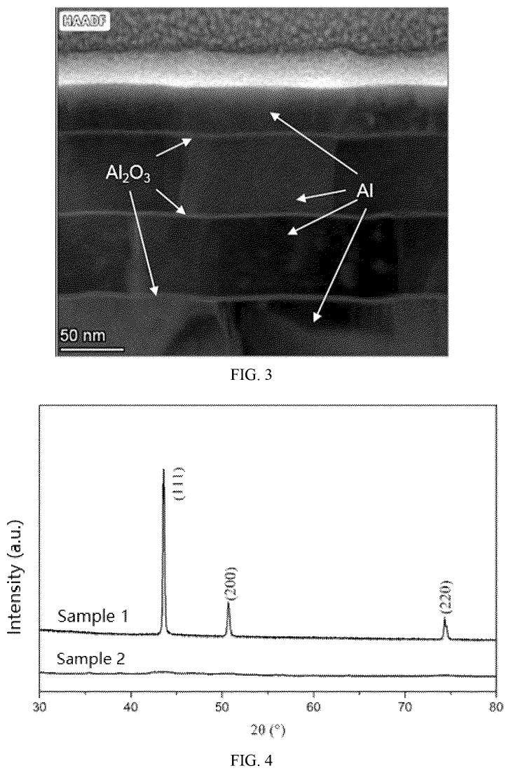

Performance testing was performed on the composite current collectors provided in the examples and comparative examples.
1. Sheet resistance: The prepared flat sample of the composite current collector was placed on a sample stage, and the sheet resistance of the sample was tested by a four-probe sheet resistance meter.
2. Safety performance
\textcircled{1} Battery assembly
i. Assembly of a lithium-ion battery based on a composite aluminum current collector: For a positive electrode, a positive current collector was the composite aluminum (that is, the metal element in the metal layer was aluminum) current collector prepared in the present disclosure (for example, Example 11 or Example 74), and an electrode material of the positive electrode was LiNi_{0.6}Mn_{0.2}Co_{0.2}O₂ (NCM622); for a negative electrode, a negative current collector was a traditional copper foil (with a thickness of 6 microns), and an electrode material of the negative electrode was artificial graphite; a separator was an alumina ceramic-coated polyethylene separator (with a thickness of 25 microns); and an electrolyte was a 1 mol/L LiPF₆ carbonate solution, where the carbonate included propylene carbonate, ethylene carbonate, and ethyl methyl carbonate with a mass ratio of 1:1:1. The lithium-ion battery was assembled using the above materials according to a related process.
ii. Assembly of a lithium-ion battery based on a composite copper current collector (that is, the metal element in the metal layer was copper): For a positive electrode, a positive current collector was a traditional aluminum current collector (with a thickness of 13 microns), and an electrode material of the positive electrode was LiNi_{0.6}Mn_{0.2}Co_{0.2}O₂ (NCM622); for a negative electrode, a negative current collector was the composite copper current collector prepared in the present disclosure (for example, the composite current collectors provided in Examples 64 to 73, Examples 75 to 84, and Comparative Examples 4 and 5), and an electrode material of the negative electrode was artificial graphite; a separator was an alumina ceramic-coated polyethylene separator (with a thickness of 25 microns); and an electrolyte was a 1 mol/L LiPF₆ carbonate solution, where the carbonate included propylene carbonate, ethylene carbonate, and ethyl methyl carbonate with a mass ratio of 1:1:1. The lithium-ion battery was assembled using the above materials according to a related process.
\textcircled{2} Safety performance testing: The safety performance of the battery was verified by a needle puncture experiment as follows: the battery prepared above was placed in a needle puncture test device, where the diameter of a needle was 3 mm, a puncturing speed was 10 mm/s, a sampling interval was 100 ms, and a sampling time was 15 min. The maximum temperature of the battery increasing in temperature during a needle puncture process and the voltage of the battery after puncturing were recorded to characterize the safety of the battery. The lower the maximum temperature and the higher the voltage of the battery after puncturing, the better the safety of the battery.
\textcircled{3} Puncture pass rate testing: The safety of the battery was verified by the needle puncture experiment as follows: 100 batteries prepared above were placed in the needle puncture test device, where the diameter of a steel needle was 3 mm, and the puncturing speed was 10 mm/s. During the needle puncture process, a battery that did not explode, catch fire, or emit smoke passed the experiment; otherwise, the battery failed. The number of batteries that passed and the number of batteries that failed were recorded, and the puncture pass rate of the battery was obtained as the number of batteries that passed/the total number of batteries×100%.
3. Tensile strength and elongation at break: The tensile strength and elongation at break of the prepared composite current collector were tested with reference to GB/T 1040.3-2006.
4. Thermal shrinkage: The thermal shrinkage of the prepared composite current collector was tested with reference to GB/T 10003-2008, where a heat treatment was performed at 150 °C for 30 min.
5. The overall morphology and local morphology of the composite current collectors prepared in Example 32 and Comparative Example 2 were observed using a transmission electron microscope. The results are shown in FIGS. 2 and 3.
6. Electrochemical performance testing
(6.1) Assembly of lithium-ion batteries

Preparation of a positive electrode sheet: A positive current collector was each of the composite current collectors prepared in the examples and comparative examples, a positive electrode active material was LiNi_{0.6}Mn_{0.2}Co_{0.2}O₂ (NCM622), a conductive agent was carbon nanotubes, a binder was polyvinylidene fluoride (PVDF), and a solvent was N-methylpyrrolidone (NMP). The positive electrode active material, the conductive agent, the binder, and the solvent were prepared at a mass ratio of 67.2%:9.4%:1.1%:22.3% into a positive electrode slurry with a certain fluidity (where the mass of the positive electrode slurry was 100%), coated on the positive current collector, and dried to form the positive electrode sheet.

Preparation of a negative electrode sheet: A negative current collector was a traditional copper foil (with a thickness of 6 μm), a negative electrode active material was artificial graphite, a conductive agent was carbon nanotubes, a binder was sodium carboxymethyl cellulose (CMC), and a solvent was pure water. The negative electrode active material, the conductive agent, the binder, and the solvent were prepared at a mass ratio of 48.0%:5.0%:19.4%:27.6% into a negative electrode slurry with a certain fluidity (where the mass of the negative electrode slurry was 100%), coated on the negative current collector, and dried to form the negative electrode sheet.

The positive electrode sheet and the negative electrode sheet were prepared into a lithium-ion battery through processes such as rolling, slicing, assembly, injection, and packaging. A separator was an alumina ceramic-coated polyethylene separator (with a thickness of 25 μm). An electrolyte was a 1 mol/L LiPF₆ carbonate solution, where the carbonate included propylene carbonate, ethylene carbonate, and ethyl methyl carbonate with a mass ratio of 1:1:1.
(6.2) The assembled lithium-ion battery was subjected to 600 charge and discharge cycles at a charge-discharge rate of 1 C, and a capacity retention rate of the battery after the charge and discharge cycles was recorded, where a voltage interval for the charge and discharge cycles was 3.0 V to 4.2 V. The capacity retention rate (%) of the battery after 600 cycles=the 600th specific discharge capacity of the battery/the 600th specific charge capacity of the battery×100%. Alternatively, the battery was subjected to 2000 charge and discharge cycles at a charge-discharge rate of 1 C, and a capacity retention rate of the battery after 2000 charge and discharge cycles was recorded as the capacity of the battery after 2000 charge and discharge cycles/the initial capacity of the battery×100%.

Table 1 shows specific test results of the preceding safety testing.

TABLE 1

| | | Maximum Temperature | | |
|---|---|---|---|---|
| | Sheet | of the Battery During | Pre- | Battery Voltage |
| | Resistance | the Needle Puncture | puncture | After 300 s of |
| | (mΩ) | Process (°C) | Voltage (V) | Puncturing (V) |
| Example 1 | 18 | 30 | 4.17 | 3.99 |
| Example 2 | 18 | 18 | 4.17 | 4.06 |
| Example 3 | 18 | 10 | 4.17 | 4.11 |
| Example 4 | 18 | 13 | 4.17 | 4.1 |
| Example 5 | 18 | 11 | 4.17 | 4.11 |
| Example 6 | 18 | 16 | 4.17 | 4.07 |
| Example 7 | 18 | 8 | 4.17 | 4.12 |
| Example 8 | 18 | 2 | 4.17 | 4.16 |
| Example 9 | 18 | 5 | 4.17 | 4.14 |
| Example 10 | 38 | 20 | 4.17 | 4.04 |
| Example 11 | 35 | 15 | 4.17 | 4.08 |
| Example 12 | 10 | 50 | 4.17 | 3.78 |
| Example 13 | 17 | 136 | 4.17 | 0.8 |
| Example 14 | 19 | 40 | 4.17 | 3.89 |
| Example 15 | 19 | 57 | 4.17 | 3.70 |
| Example 16 | 18 | 150 | 4.17 | 0.6 |
| Example 17 | 20 | 128 | 4.17 | 0.9 |
| Example 18 | 36 | 60 | 4.17 | 3.66 |
| Example 19 | 15 | 6 | 4.17 | 4.13 |
| Example 20 | 21 | 4 | 4.17 | 4.14 |
| Example 21 | 19 | 4 | 4.17 | 4.14 |
| Example 22 | 24 | 180 | 4.17 | 0.5 |
| Example 23 | 18 | 260 | 4.17 | 0 |
| Example 24 | 18 | 45 | 4.17 | 3.83 |
| Example 25 | 17 | 19 | 4.17 | 4.04 |
| Example 26 | 18 | 46 | 4.17 | 3.82 |
| Example 27 | 18 | 59 | 4.17 | 3.67 |
| Example 28 | 18 | 89 | 4.17 | 1.98 |
| Example 29 | 18 | 30 | 4.17 | 3.99 |
| Example 30 | 18 | 105 | 4.17 | 1.21 |
| Comparative | 18 | 516 | 4.17 | 0 |
| Example 1 | | | | |

Table 2 shows the results of the puncture pass rate.

TABLE 2

| | Tensile Strength (MPa) | Puncture Pass Rate (%) |
|---|---|---|
| Example 50 | 240 | 86 |
| Example 51 | 256 | 73 |
| Example 52 | 222 | 89 |
| Example 53 | 207 | 91 |
| Example 54 | 260 | 93 |
| Example 55 | 222 | 79 |
| Example 56 | 211 | 70 |
| Example 57 | 231 | 67 |
| Example 58 | 235 | 91 |
| Example 59 | 233 | 90 |
| Example 60 | 238 | 96 |
| Example 61 | 180 | 30 |
| Example 62 | 190 | 50 |
| Example 63 | 200 | 47 |
| Comparative | 175 | 15 |
| Example 3 | | |

As can be seen from the test results of Examples 1 to 29 and Comparative Example 1, compared with the traditional composite current collector, the composite current collectors of the present disclosure significantly improve the safety of the batteries.

As can be seen from the test results of Examples 1 to 9, compared with the composite current collectors in which the intermediate layers were made of a single substance, the composite current collectors in which the intermediate layers were made of a substance combination better improve the safety of the batteries.

As can be seen from the test results of Examples 1 and 11 to 13, as the thickness of the metal layer increases, the safety of the battery based on the prepared composite current collector was improved and then deteriorated, and when the thickness exceeds a certain range, the safety was significantly deteriorated because an excessively thick metal layer resulted in very long columnar crystals in the layer, which is not conducive to the propagation of cracks during the needle puncture process.

As can be seen from the test results of Examples 1 and 14 to 16, the larger the average grain size of the metal grains in the metal layer, the higher the maximum temperature of the battery during the needle puncture process and the greater the voltage of the battery after puncturing drops, that is, the worse the safety of the battery. This was because the smaller grains could better promote the propagation of microcracks generated in the metal layer during the needle puncture process and caused large-area fractures of the metal layer, thereby separating the metal layer from the steel needle. However, excessively large grains led to stronger plasticity of the metal layer, which was not conducive to the large-area fractures of the metal layer during the needle puncture process; therefore, the prepared composite current collector had a worse effect in improving the safety of the battery.

Compared with Example 1, Example 17 exhibits seriously deteriorated safety in that the maximum temperature during the needle puncture process reaches 128 °C, and the battery voltage after 300 s of puncturing is 0.9 V. This is because, when the intermediate layer was in direct contact with the adhesive layer, the adhesion strength between the metal layer and the polymer film was too strong, which was not conducive to local micro-deformation and the propagation of microcracks during the needle puncture process and results in a failure to improve the safety.

As can be seen from the test results of Examples 1 and 18 to 22, if the number of metal layers was too small and less than 5, the maximum temperature during the needle puncture process increased significantly, and the voltage after puncturing decreased significantly, indicating a much worse effect in improving the safety; if the number of metal layers was greater than 40, the safety of the battery could not be further improved, the production efficiency was affected, and the production difficulty was increased. Therefore, the number of layers optionally ranges from 5 to 40.

As can be seen from the test results of Examples 1 and 23 to 25, the thickness of the intermediate layer within an appropriate range bad a small effect on a change of the sheet resistance, that is, had a small effect on the conductivity of the composite current collector, indicating that with the thickness of the intermediate layer well controlled, the stacked structure of alternate metal layers and intermediate layers did not significantly affect the conductivity of the composite current collector. The thicker the intermediate layers, the better the safety of the battery based on the prepared composite current collector. This is because the greater thickness of the intermediate layer within the appropriate range yielded the better effects in inhibiting the continuous growth of grains in the metal layer and blocking the interconnection between different metal layers. When the intermediate layers were too thin, the continuous growth of grains in the metal layers could not be effectively inhibited, resulting in partial penetration of grains in adjacent metal layers and sharply deteriorated safety of the battery.

As can be seen from the test results of Examples 1, 26 to 28, and 30, as the adhesion strength between the conductive layer and the base film increased, the safety of the battery based on the prepared composite current collector was improved and then deteriorated. This was because too weak adhesion strength easily led to too large a relative motion between the conductive layer and the polymer film during the needle puncture process of the battery, which was not conducive to applying a sufficient force to the conductive layer along a surface, inhibited the large-area extension and propagation of cracks in the conductive layer, and deteriorated the safety of the battery; however, too strong adhesion strength made local micro-deformation hard to occur, which was not conducive to the large-area extension and propagation of the cracks in the conductive layer and affected an improvement in the safety of the battery. Further, no adhesive layer in the composite current collector was not conducive to a significant improvement in the safety of the battery.

As can be seen from the data results of Example 1 and Comparative Example 1, only through the collaboration of structures in the functional layer in the composite current collector structure of the present disclosure, could the conductive layer be separated from the steel needle during the needle puncture process, thereby avoiding a closed loop due to the conduction between the positive and negative current collectors and the resulting thermal runaway of the battery and greatly improving the safety of the battery.

As can be seen from Examples 50 to 63 and Comparative Example 3, compared with the traditional composite copper current collector, the composite copper current collectors prepared in the present application had improved tensile strength (mechanical performance), and the puncture pass rates of the batteries based on the prepared composite current collectors were improved, that is, the safety was improved due to the stacked structure of amorphous copper and crystalline copper in the conductive layer.

As can be seen from Examples 50 to 53 and 62, as the thickness of amorphous copper in the conductive layer increased, the tensile strength of the composite current collector was improved and then reduced. This was because the introduction of relatively thin amorphous copper could buffer the movement of crystalline copper in the stretching process, thereby improving the tensile strength of the composite current collector; however, excessively large thickness resulted in a high thickness ratio of amorphous copper to crystalline copper, and the conductive layer exhibited certain characteristics of amorphous copper, resulting in the reduced tensile strength. As the thickness of amorphous copper in the conductive layer increased, the puncture pass rate of the battery based on the prepared composite current collector showed an increasing trend, while too large a thickness led to a decrease in the puncture pass rate. This is because, as the thickness of amorphous copper increased, the amorphous copper layer was easy to generate cracks during deformation due to needle puncturing, and the generated cracks were more likely to propagate rapidly to the surroundings and more likely to drive the large-area fractures of adjacent crystalline copper layers, thereby improving the safety of the battery. However, amorphous copper with excessively large thickness transforms into crystalline copper during preparation, which was not conducive to the generation of cracks and the propagation of the cracks to the surroundings during the needle puncture process, reducing the safety of the battery.

As can be seen from Examples 50, 54 to 56, and 63, as the thickness of crystalline copper in the conductive layer increased, the tensile strength of the composite copper current collector and the puncture pass rate of the battery based on the composite copper current collector both showed a decreasing trend. This is because, as the thickness of crystalline copper increased, copper grains had a greater dimension along the thickness direction, resulting in a decrease in the tensile strength of the composite copper current collector. An increase in the dimension of grains made it difficult for amorphous copper to drive crystalline copper to generate large-area cracks, resulting in a decrease in the puncture pass rate and the deteriorated safety.

As can be seen from Examples 50, 57, 58, and 61, as the number of amorphous copper layers and the number of crystalline copper layers in the conductive layer increased, the tensile strength of the prepared composite current collector was improved and then reduced, while the puncture pass rate of the battery based on the composite copper current collector showed an increasing trend. This is because an increase in the number of layers could promote the generation of cracks in the conductive layer and the rapid propagation of the cracks to the surroundings during the needle puncture process, thereby improving the safety of the battery.

As can be seen from Examples 50, 59, and 60, when the amorphous copper layer was prepared by a method combining magnetron sputtering and evaporation, the prepared composite copper current collector had a better effect in improving the safety of the battery.

Table 3 shows the test results of the mechanical performance and the electrochemical performance.

TABLE 3

| | | | | | Capacity | |
|---|---|---|---|---|---|---|
| | | | | | Retention | |
| | | | | | Rate (%) of | |
| | | | | | the Battery | |
| | | | | | After 600 | |
| | | | | | Cycles at a | |
| | | | | | Charge- | |
| | Sheet | Tensile | Elongation | Thermal | Discharge | Puncture |
| | Resistance | Strength | at Break | Shrinkage | Rate of 1 C | Pass |
| Group | (mΩ) | (MPa) | (%) | (%) | (%) | Rate |
| Example 31 | 35 | 190 | 16 | 0.1 | 83 | 70 |
| Example 32 | 37 | 220 | 25 | 0 | 88 | 90 |
| Example 33 | 38 | 231 | 30 | 0 | 91 | 93 |
| Example 34 | 35 | 214 | 27 | 0 | 89 | 85 |
| Example 35 | 35 | 226 | 23 | 0 | 87 | 87 |
| Example 36 | 36 | 210 | 20 | 0 | 85 | 89 |
| Example 37 | 35 | 230 | 29 | 0 | 89 | 86 |
| Example 38 | 36 | 228 | 23 | 0 | 87 | 88 |
| Example 39 | 36 | 195 | 19 | 0 | 88 | 82 |
| Example 40 | 36 | 203 | 22 | 0 | 89 | 85 |
| Example 41 | 59 | 208 | 33 | 0.2 | 81 | 76 |
| Example 42 | 17 | 182 | 11 | 0 | 87 | 65 |
| Example 43 | 90 | 213 | 40 | 0.5 | 77 | 79 |
| Example 44 | 37 | 199 | 19 | 0 | 86 | 74 |
| Example 45 | 39 | 192 | 21 | 0 | 84 | 78 |
| Example 46 | 46 | 185 | 22 | 0 | 79 | 80 |
| Example 47 | 58 | 205 | 27 | 0.24 | 79 | 51 |
| Example 48 | 35 | 197 | 18 | 0.15 | 82 | 70 |
| Example 49 | 34 | 185 | 14 | 0.13 | 80 | 62 |
| Comparative | 34 | 155 | 9 | 0.3 | 75 | 20 |
| Example 2 | | | | | | |

As can be seen from Table 3, compared with that in Comparative Example 2, the composite current collectors prepared in Examples 31 to 49 had significantly improved tensile strength, elongation at break, and cycle performance, indicating that the metal oxide layer improved the elongation at break and tensile strength of the composite current collector and inhibited the corrosion of the composite current collector by the electrolyte to a certain extent, thereby improving the stability of the composite current collector.

As can be found through the comparison of the sheet resistance data of Examples 31 to 40, 44, and 45 and Comparative Example 2, in the case where the total thickness of the metal layers in the composite current collector was basically the same, the stacked structure of alternate metal layers and metal oxide layers in Examples 31 to 40, 44, and 45 did not significantly affect the conductivity of the composite current collector. The total thickness of the metal layers in each of the composite current collectors in Examples 41 to 43 and 47 had a relatively large difference from the total thickness of the metal layers in Example 31, and accordingly, the sheet resistance of the composite current collectors in Examples 41 to 43 had relatively large changes. Compared with that in Example 31, the composite current collector in Example 46 had relatively high sheet resistance due to a relatively high proportion of the thickness of the metal oxide layer. Compared with that in Example 31, the composite current collector in Example 43 had relatively high thermal shrinkage due to a relatively large difference between the total thickness of the metal layers in the current collector in Example 43 and the total thickness of the metal layers in the current collector in Example 31. Additionally, although the composite current collectors in Examples 41 to 43 and 47 changed in the sheet resistance or thermal shrinkage, the capacity retention rates of the batteries in Examples 41 to 43 and 47 were still significantly higher than the capacity retention rate of the battery in Comparative Example 2.

Table 4 shows the capacity retention rates of the batteries after 2000 cycles and the puncture pass rates of the batteries in some examples.

TABLE 4

| | Capacity Retention | Puncture Pass Rate |
|---|---|---|
| | Rate of the Battery | of the Battery |
| | (%) | (%) |
| Example 64 | 82.1 | 89.0 |
| Example 65 | 86.2 | 92.0 |
| Example 66 | 81.7 | 88.0 |
| Example 67 | 80.4 | 80.0 |
| Example 68 | 78.1 | 77.0 |
| Example 69 | 88.8 | 95.0 |
| Example 70 | 89.6 | 96.0 |
| Example 71 | 74.5 | 65.0 |
| Example 72 | 78.1 | 84.0 |
| Example 73 | 87.3 | 93.0 |
| Example 74 | 83.3 | 92.0 |
| Example 75 | 80.3 | 85.0 |
| Example 76 | 68.4 | 72.0 |
| Example 77 | 71.2 | 78.0 |
| Example 78 | 80.1 | 63.0 |
| Example 79 | 81.2 | 96.0 |
| Example 80 | 67.5 | 45.0 |
| Example 81 | 88.1 | 94.0 |
| Example 82 | 63.9 | 25.0 |
| Example 83 | 57.6 | 63.0 |
| Example 84 | 63.1 | 66.0 |
| Comparative | 51.2 | 13.0 |
| Example 4 | | |
| Comparative | 80.5 | 88.0 |
| Example 5 | | |

Additionally, the elongation at break of Example 64 and Comparative Example 5 was tested. The elongation at break was tested by the following method: the prepared composite current collector was sampled along a longitudinal direction, and then the elongation at break was tested with reference to GB/T 1040.3-2006.

Table 5 shows the test results.

TABLE 5

| | Elongation at Break (%) |
|---|---|
| Example 64 | 29.6 |
| Comparative Example 5 | 7.8 |

As can be seen from Table 4 and Table 5, compared with the traditional composite current collector, due to the introduction of the intermediate layer, the prepared composite current collector could improve the capacity retention rate and puncture pass rate of the battery, that is, improve the charge-discharge cycle performance and safety of the battery.

As can be seen from Examples 64 to 67 and 78, as the thickness of the metal layer increased, the charge discharge cycle performance and safety of the battery based on the composite copper current collector showed an increasing and then decreasing trend. This may be because a change in the thickness of the metal layer affected the grain size along the thickness direction of the metal layer and thus affected the fractures of the metal layer during the needle puncture process, causing changes in safety. Meanwhile, the change in the grain size along the thickness direction also affected the conduction resistance of electrons in the charge and discharge process of the battery and thus affected the charge discharge cycle performance of the battery.

As can be seen from Examples 65, 68 to 70, and 79 to 80, as the thickness of the intermediate layer increased, the charge-discharge cycle performance of the battery based on the composite copper current collector showed an increasing trend, and the charge-discharge cycle performance was worse beyond a certain thickness. This may be because an increase in the thickness of the intermediate layer can improve the barrier and tolerance of the intermediate layer to the electrolyte, thereby promoting an improvement in the charge-discharge cycle performance of the battery based on the composite copper current collector; however, an excessively thick intermediate layer affects the conductivity of the conductive layer, deteriorating the charge-discharge cycle performance of the battery based on the composite copper current collector. As the thickness of the intermediate layer increased, the safety of the battery based on the composite copper current collector showed a trend of increasing and then remaining unchanged. This may be because an increase in the thickness of the intermediate layer can promote the large-area fractures of the conductive layer during the needle puncture process so that the conductive layer was more easily disconnected from the steel needle, thereby promoting an improvement in the safety of the battery based on the composite copper current collector. However, when the thickness exceeded a certain value, the effect is not further promoted, resulting in unchanged safety.

As can be seen from Examples 65, 71 to 73, and 81 to 82 and Comparative Example 4, as the number of metal layers and the number of intermediate layers increased, the charge-discharge cycle performance and safety of the battery based on the composite copper current collector both showed an increasing trend. This may be because an increase in the number of layers can improve the multi-layer structure of alternate intermediate layers and metal layers and promoted the layer-by-layer protection of the metal layer, thereby promoting an improvement in the charge discharge cycle performance of the battery; moreover, an increase in the number of layers can promote the large-area fractures of the conductive layer during the needle puncture process so that the conductive layer is more easily disconnected from the steel needle, thereby promoting an improvement in the safety of the battery based on the composite copper current collector. However, when the number of layers exceeded 15, the performance improvements were insignificant. Considering the preparation efficiency of the composite current collector, the number of layers is optionally 5 to 15.

As can be seen from Examples 64, 76 to 77, and 83 to 84, in the chemical composition CₓF_{y} of the fluorocarbon polymer in the intermediate layers, if x/y was too low, that is, the carbon content was too low, the intermediate layer exhibited worse conductivity, and thus the prepared composite current collector had worse conductivity, resulting in worse cycle performance of the battery; if x/y was too high, that is, the carbon content was too high, the intermediate layer exhibited worse flexibility and was prone to defects, resulting in worse cycle performance of the battery.

As can be seen from Example 64 and Comparative Example 5, if the fluorocarbon layer was replaced with the carbon layer, compared with the fluorocarbon layer, the carbon layer can improve the overall performance of the traditional composite current collector, for example, improve the corrosion resistance. However, the addition of the carbon layer reduced the elongation at break of the material and made the material more likely to break during preparation of the electrode sheet, resulting in a reduced yield of the prepared battery electrode sheets. This is because the carbon layer was more brittle than the fluorocarbon polymer and resulted in an increase in the brittleness of the overall material.

To conclude, according to the composite current collector structure of the present disclosure, through the collaboration of various structural layers in the functional layer, during the needle puncture process, the conductive layer generates the microcracks and the microcracks propagate rapidly to cause the large-area fractures so that the conductive layer is separated from the steel needle, thereby avoiding the closed loop due to the conduction between the positive and negative current collectors and the resulting thermal runaway of the battery, improving the safety of the battery, and facilitating the promotion and application of the composite current collector.

The applicant states that the embodiments of the present disclosure are described above and are not intended to limit the scope of the present disclosure. Those skilled in the art are to understand that any modifications or substitutions easily conceivable by those skilled in the art within the technical scope disclosed herein fall within the scope of the present disclosure.

1: A composite current collector, comprising a conductive layer, wherein the conductive layer comprises a metal layer and an intermediate layer stacked alternately.

2: The composite current collector according to claim 1, comprising a base film and a functional layer located on at least one side of the base film, wherein the functional layer comprises the conductive layer.

3: The composite current collector according to claim 2, wherein the base film has a thickness of 1-10 μm; optionally, the base film is made of any one or a combination of at least two selected from polyethylene terephthalate, polypropylene, polybutylene terephthalate, polyethylene naphthalate, polyethylene, polyphenylene ether, polyvinyl chloride, polyvinylidene fluoride, polytetrafluoroethylene, polyphenylene sulfide, polyphenylene oxide, polystyrene, and polyimide.

4: The composite current collector according to claim 2, wherein the composite current collector further comprises an adhesive layer between the base film and the conductive layer; optionally, adhesion strength between the adhesive layer and the conductive layer is 100-900 N/m; optionally, the adhesive layer is made of any one or a combination of at least two selected from aluminum oxide, silicon oxide, titanium oxide, nickel, chromium, titanium, a nickel-chromium alloy, a nickel-chromium-copper alloy, a silicon-aluminum alloy, polyacrylic acid, polyacrylate, polyacrylamide, and polyurethane.

5: The composite current collector according to claim 1, wherein the metal layer comprises a metal that is any one or a combination of at least two selected from aluminum, copper, gold, silver, nickel, zinc, and an alloy thereof.

6: The composite current collector according to claim 1, wherein the intermediate layer is made of an amorphous conductive material; optionally, the amorphous conductive material is amorphous copper.

7. (canceled)

8: The composite current collector according to claim 6, wherein a thickness d1 of the metal layer is 0 nm<d1≤300 nm; optionally, the thickness d1 of the metal layer is 50 nm<d1≤200 nm; and a thickness d2 of the intermediate layer is 0 nm<d2≤100 nm; optionally, the thickness d2 of the intermediate layer is 20 nm<d2≤80 nm.

9: The composite current collector according to claim 1, wherein the intermediate layer is made of any one or a combination of at least two selected from a fluorocarbon material, an oxide, an alloy, a nitride, a carbide, a sulfide, a fluoride, a silicide, and a phosphide; optionally, the intermediate layer is made of any one or a combination of at least two selected from the carbide, the silicide, and the fluoride.

10: The composite current collector according to claim 9, wherein the fluorocarbon material in the intermediate layer comprises a fluorocarbon polymer; optionally, a chemical composition of the fluorocarbon polymer is CₓF_{y}, wherein 0.6≤x/y≤10; the oxide in the intermediate layer comprises one or more of a metal oxide or a non-metal oxide; optionally, the metal oxide is selected from one or more selected from aluminum oxide, titanium oxide, copper oxide, nickel oxide, chromium oxide, zinc oxide, magnesium oxide, cobalt oxide, zirconium oxide, tin oxide, and indium tin oxide, and the non-metal oxide is silicon oxide; the alloy in the intermediate layer comprises any one or a combination of at least two selected from a nickel-chromium alloy, a nickel-chromium-copper alloy, a nickel-chromium-silicon alloy, a nickel-chromium-cobalt alloy, a silicon-aluminum alloy, an aluminum-silicon-copper alloy, a copper-nickel alloy, a copper-nickel-titanium alloy, a copper-gallium alloy, a copper-indium alloy, a copper-indium-gallium alloy, an aluminum-tin-copper alloy, an aluminum-chromium alloy, a tungsten-titanium alloy, a molybdenum-copper alloy, a molybdenum-niobium alloy, a molybdenum-tantalum alloy, a molybdenum-zirconium-titanium alloy, and a molybdenum-lanthanum alloy; the nitride comprises any one or a combination of at least two selected from aluminum nitride, boron nitride, chromium nitride, titanium nitride, silicon nitride, niobium nitride, zirconium nitride, hafnium nitride, tantalum nitride, vanadium nitride, and aluminum titanium nitride; the carbide comprises any one or a combination of at least two selected from aluminum carbide, boron carbide, chromium carbide, nickel carbide, tungsten carbide, titanium carbide, hafnium carbide, zirconium carbide, tantalum carbide, lanthanum carbide, molybdenum carbide, niobium carbide, silicon carbide, titanium carbide, and vanadium carbide; the sulfide comprises any one or a combination of at least two selected from copper sulfide, tin sulfide, zinc sulfide, tungsten sulfide, molybdenum sulfide, iron sulfide, antimony sulfide, chromium sulfide, nickel sulfide, titanium sulfide, aluminum copper sulfide, and iron copper sulfide; the fluoride comprises any one or a combination of at least two selected from iridium fluoride, magnesium fluoride, calcium fluoride, lithium fluoride, aluminum fluoride, barium fluoride, samarium fluoride, cerium fluoride, yttrium fluoride, and scandium fluoride; the silicide comprises any one or a combination of at least two selected from cobalt silicide, chromium silicide, nickel silicide, titanium silicide, hafnium silicide, molybdenum silicide, niobium silicide, tantalum silicide, vanadium silicide, tungsten silicide, and zirconium silicide; and the phosphide comprises any one or a combination of at least two selected from aluminum phosphide, boron phosphide, copper phosphide, nickel phosphide, silicon phosphide, tungsten phosphide, gallium phosphide, germanium phosphide, indium phosphide, molybdenum phosphide, niobium phosphide, and tantalum phosphide.

11: The composite current collector according to claim 9, wherein a thickness d1 of the metal layer is 0 nm<d1≤200 nm; optionally, a thickness d2 of the intermediate layer is 1 nm≤d2≤50 nm; optionally, 2 nm≤d2≤50 nm; more optionally, 5 nm≤d2≤20 nm; further optionally, 10 nm≤d2≤20 nm; optionally, the thickness d2 of the intermediate layer is less than or equal to one tenth of the thickness d1 of the metal layer.

12: The composite current collector according to claim 9, wherein the intermediate layer is made of a non-crystalline (amorphous) or partially crystalline material.

13: The composite current collector according to claim 1, wherein a thickness of the conductive layer on a surface of a polymer base film is 500-2000 nm and optionally 800-1200 nm; optionally, the conductive layer comprises n metal layers and n, n−1, or n+1 intermediate layers, wherein n satisfies that 2≤n≤50; optionally, 2≤n≤15; more optionally, 5≤n≤10.

14: The composite current collector according to claim 1, wherein the intermediate layer and the metal layer have non-porous structures; optionally, the metal in the metal layer is crystalline, and an average grain size of grains is 0-200 nm excluding 0 and optionally 10-100 nm.

15. (canceled)

16: The composite current collector according to claim 1, wherein the composite current collector further comprises a protective layer on a surface of the conductive layer facing away from the base film; optionally, when the composite conductive layer is disposed on one surface of the polymer base film, the protective layer is disposed on a surface of the composite conductive layer facing away from the polymer base film and the other surface of the polymer base film; or when the composite conductive layer is disposed on one surface of the polymer base film, the protective layer is disposed on a surface of the composite conductive layer facing away from the polymer base film; or when the composite conductive layer is disposed on two surfaces of the polymer base film, the protective layer is disposed on a surface of the composite conductive layer facing away from the polymer base film; optionally, a thickness of the protective layer is 5-100 nm and optionally 20-80 nm; optionally, the protective layer is made of any one or a combination of at least two selected from nickel, chromium, a nickel-based alloy, a copper-based alloy, copper oxide, aluminum oxide, nickel oxide, chromium oxide, cobalt oxide, copper chromium oxide, graphite, carbon black, copper chromate, copper chromite, carbon nano-quantum dots, carbon nanotubes, carbon nanofibers, graphene, and graphene oxide.

17: The composite current collector according to claim 1, wherein during a needle puncture process, the conductive layer generates microcracks and the microcracks propagate to cause large-area fractures so that the conductive layer is separated from a steel needle.

18: A preparation method for the composite current collector according to claim 1, comprising: preparing a composite conductive layer on at least one surface of a base film, wherein the conductive layer comprises a metal layer and an intermediate layer stacked alternately.

19: The preparation method for the composite current collector according to claim 18, wherein an adhesive layer is further provided between the base film and the conductive layer; optionally, the adhesive layer is prepared by a method comprising magnetron sputtering, evaporation, or coating; optionally, the metal layer is prepared by a method comprising electroplating, chemical plating, evaporation, and/or magnetron sputtering; optionally, the intermediate layer is prepared by a method comprising chemical vapor deposition, evaporation, or magnetron sputtering; optionally, after the conductive layer is prepared, a protective layer is further provided on a surface of the conductive layer facing away from the base film; optionally, the protective layer is prepared by a method comprising any one or a combination of at least two selected from physical vapor deposition, chemical vapor deposition, in-situ forming, and coating.

20: The preparation method for the composite current collector according to claim 18, wherein the preparation method comprises the following steps: alternately depositing the intermediate layer and the metal layer on each of two surfaces of a polymer base film to form the composite conductive layer; wherein the intermediate layer is prepared by the method comprising the magnetron sputtering, the chemical vapor deposition, or the evaporation; optionally, specific process parameters of the magnetron sputtering comprise target power of 1-10 kW, a vacuum degree ≤0.5 Pa, a gas flowrate of 10 mL/min to 500 mL/min, and a coating time of 0.1 s to 60 s for a single intermediate layer; optionally, specific process parameters of the evaporation comprise a vacuum degree <0.5 Pa, a gas flowrate of 10 mL/min to 500 mL/min, and a period of 0.1 s to 10 s for each deposition; the metal layer is prepared by the method comprising the evaporation, the magnetron sputtering, or the electroplating; optionally, specific process parameters of the magnetron sputtering comprise any one of a copper target, an aluminum target, or a copper-aluminum alloy target, target power of 5-20 kW, a gas flowrate of 10-500 mL/min, a vacuum degree ≤0.5 Pa, and a coating time of 0.1-120 s for a single metal layer; or optionally, specific process parameters of the electroplating comprise an average cathode current density of 1-3 A/dm², a plating solution temperature of 15-35 °C, and an electroplating time of 1-90 s; optionally, specific process parameters of the evaporation comprise a high-purity metal wire (purity ≥99.9%) as a raw material, a heating temperature higher than a melting point of the metal wire, a vacuum degree of a vacuum chamber less than or equal to 0.1 Pa, a period of 0.5-100 s for each coating, and a main roller cooling temperature of −30 °C to 10 °C.

21: The preparation method for the composite current collector according to claim 20, wherein the preparation method further comprises the following steps: depositing the protective layer on the surface of the composite conductive layer facing away from the polymer base film by a coating method, wherein specific process steps of the coating method comprise: coating a coating solution of the protective layer on the surface of the composite conductive layer, and drying to obtain the protective layer.

22: A battery, comprising the composite current collector according to claim 1; optionally, the composite current collector is used in an electrode sheet of the battery.
